(19) United States
(12) Patent Application Publication
(10) Pub. No.: US 2023/0153120 A1
(43) Pub. Date: May 18, 2023

(54) SYSTEM AND METHOD FOR CLOUD DEPLOYMENT AND MANAGEMENT

(71) Applicant: Marshmallow Jetpack Inc, Laguna Hills, CA (US)

(72) Inventor: Rusty LOPEZ, Highland, UT (US)

(21) Appl. No.: 17/969,696

(22) Filed: Oct. 20, 2022

Related U.S. Application Data
(60) Provisional application No. 63/271,162, filed on Oct. 24, 2021.

(51) Int. Cl. G06F 9/445; G06F 8/60

(52) U.S. Cl. CPC G06F 9/44505; G06F 8/60

(57) ABSTRACT

A system and method for infrastructure deployment and management which automatically deploy an application, for example to the cloud, within a templated infrastructure for supporting data and services. The system and method are built upon any unambiguous relational data model which, having all relationships sufficiently defined, can be combined with previously defined infrastructure and user interface templates, to produce an automatically generated application. The general purpose, infrastructure and user interface templates take the data definition as input to produce business domain specific infrastructure and user interface definitions as output. These concrete, business domain specific definitions are then used to automatically provision and generate interactive data management applications. The infrastructure template takes a data definition as an input and generates infrastructure as an output.

### FIELD OF THE INVENTION

The present invention is of a system and method for software application, deployment and management, and in particular, to such a system and method which automatically deploy an application within a templated infrastructure to support data and services.

### BACKGROUND OF THE INVENTION

Management of “Configuration Data” is essential to nearly all software applications, and is particularly important to cloud deployed applications. In order to reliably and consistently auto generate a data management application, from a data model, it is important that all data models and data model associations should be defined in a consistent way. Furthermore, such a definition needs to be sufficiently flexible to include all potential associations. These requirements are particularly important for systems that automatically generate cloud deployed applications.

A proper configuration data management system is therefore clearly important to cloud deployed applications. Yet many organizations redesign these configuration data management systems from the ground up - and then, rather than reusing the designed configuration data management system from one cloud deployed application, they often repeat this design, develop and implement process repeatedly for each new collection of configuration data that they need to host. This repeated process is not only wasteful of resources, but is problematic for automatically deploying cloud based applications.

An organization may not realize that disparate “configuration data management” implementations have commonalities that could be potentially deployed with a single management system. The commonalities may also not be recognized until the organization has built up such significant amounts of non-reusable, non-portable software around it that undoing all of that development is too expensive, and prohibits transition to a more general purpose solution. Even when transition to a more general purpose configuration data management solution is made, such solutions do not generally cover all concerns of configuration state management and are often relegated to one tier of the application software stack such as the user interface alone, the database schema design alone, the API alone and so forth.

### BRIEF SUMMARY OF THE INVENTION

The present invention, in at least some embodiments, overcomes the drawbacks of the background art by providing a system and method for software application, deployment and management which automatically deploy an application, for example to the cloud, within a templated infrastructure for supporting data and services. The system and method are built upon any unambiguous relational data model which, having all relationships sufficiently defined, can be combined with previously defined infrastructure and user interface templates, to produce an automatically generated application. The general purpose, infrastructure and user interface templates take the data definition as input to produce business domain specific infrastructure and user interface definitions as output. These concrete, business domain specific definitions are then used to automatically provision and generate interactive data management applications. The infrastructure template takes a data definition as an input and generates infrastructure as an output.

Such a template preferably incorporates a data schema for defining data model associations that allows for either end of an association to be defined as an abstraction, more specifically as Polymorphic Type Unions. The data schema preferably defines data elements that resolve concrete values for various configurable regions within the template. In order for these templates to be versatile enough to cover the majority of business use cases, the data model schema supports explicit definition of data model associations in a consistent manner.

If the data schema does not allow for definition of data model associations, the data schema is not likely to be flexible enough to support describing all of an organization’s data models, as there may be cases for some associations, where multiple concrete conceptual data models are valid on one end or another or all ends of an association. If the format for defining associations does not support abstractions or polymorphic type unions on any end on any end of the association, then associations that could or should incorporate such abstractions or polymorphic type unions on any end cannot be defined using this format. Such a limitation may result in only a subset of all associations that the organization requires being defined within that format. This limitation may require some or all of the data associations defined by the organization, be defined with some other format, or else those data associations may be insufficiently, vaguely or ambiguously defined.

One non-limiting example of such an abstraction or polymorphic type union would be a grouping of the different types of items that can appear on a purchase invoice. A purchase invoice could be composed of many very distinct purchasable goods. However all of these items have in common, the aspect of being “purchasable” and any qualities that are essential to that union membership, including for example association to a price or cost. The abstraction in this example is the general support for purchase or to be “purchasable” and the polymorphic type union is all conceptual data entities defined within a business domain that can be considered “purchasable”. Examples of these conceptual data entities that are purchasable may be for example food items if the business domain is a grocery store. Carrots, and apples may be examples of concrete, conceptual data entities that are purchasable. They are distinct, concrete concepts but share commonalities in their association to a price and the ability to purchase them. These concrete, specific, conceptual data entities are referred to as ‘Primary Entities″ within the context of this document. A data object that is a “Primary Entity” inherits all the obligations and concerns and compatibilities imbued by that membership.

Other concrete forms of data may then declare membership within that type union and would be therefore capable of interactions as for any other Primary Entity in that type union. The Relational Form as described herein allows definition of custom abstractions such as the “Purchasable” type union in the example generated data management application, described below.

By contrast, ambiguously or inconsistently defined data associations, such as those associations used in manually defined data models, are not directly suitable for automated system identification and interpretation, and may therefore require evaluation by a human developer or designer, any other system capable of generalization or inference, capable of inferring the existence and nature of the association. Such a human developer or designer, or suitable automated system, would then need to subsequently author the necessary application, service, infrastructure or interface source code, required to address composition of data management application components that address management of data model outliers, which are not described, or are not fully or accurately described. The requirement for human programming is deleterious to any automated system for cloud configuration and deployment. Such a mixed system is not only less efficient, but is also potentially susceptible to a greater level of errors.

Thus, preferably the automated system as described herein is capable of automatically generating data management applications, by incorporating a schema (format) for defining associations. The format as described herein allows for any association defined to include an abstraction or polymorphic type union, comprising multiple forms of conceptual data, on an end of the association. The system preferably leverages that format, to define the associations in their data model, so as to be able to rely on that resulting consistency and comprehensiveness in their data model, to automatically generate such data management applications according to the process as described herein.

As described herein, “Configuration Data” modifies operation or processing of a software application or procedure. It may be provided by a human or from another process.

Although the description of various embodiments focusses on “configuration data management” applications that are hosted in cloud computing environments, the system and method as described herein is very easily adapted to deploy configuration data storage that is hosted and served locally from desktop or mobile applications. The user interface generation may be done in those desktop or mobile application environments as well, using the user interface description languages native to those environments.

Within the present invention, a software application in a cloud or other computing environment is created according to a template. The data is defined so that the templated infrastructure description can be combined with the data definition to produce the software application. Unlike art known systems, the system of the present invention uses data definitions as an input to these infrastructure templates, to support generation of the software application. In art known systems, by contrast, a detailed, manually generated definition is required as an input to generate the infrastructure. Art known systems therefore require extensive manual work by designers and developers, and other programmers, for implementation. The art known approach requires such extensive manual work because the description of the software needs to be adjusted for specific data cases. By starting with a templated data definition, the present invention is able to avoid such specific manual adjustments.

Without wishing to be limited by a closed list, the present invention overcomes the drawbacks of the background art by limiting human involvement (for example by an engineer), to the submission of a set of reusable templates, for the reasons discussed above; and by decoupling the work of the human engineer from the data definition to infrastructure creation process. However in the art known approach, a human engineer must be involved for every update to the data model definition.

The templates of the present invention are re-usable because the data associations are clearly and consistently defined with support for polymorphic type unions at either end of the association. The template definition is compatible with the Relational Data Form as described below. Afterward, a data definition update, made by the data designer, need not involve an infrastructure engineer.

Once the template has been created, a virtual machine may be provisioned according to the data infrastructure generated by the template. Provisioning a virtual machine according to a template is well known in the art, and is supported by many different art known systems for supporting virtualization, known as virtualization platforms. For example, such a virtualization platform may be provided as a hypervisor which uses hardware-assisted virtualization. Non-limiting examples of such virtualization platforms include KVM, VMware Workstation, VMware Fusion, Hyper-V, Windows Virtual PC, Xen, Parallels Desktop for Mac, Oracle VM Server for SPARC, VirtualBox, Parallels Workstation, and so forth. The virtual machine may be created with a supportive system of such a virtualization platform, through a computational device in a computer system as described herein (which may include a plurality of such devices and/or a cloud based virtual machine and/or processor and memory, as is known in the art). The virtual machine may then be deployed to the cloud, for example through a commercial cloud provider such as Microsoft Azure, Amazon AWS, or Google Cloud. The data infrastructure generated according to the template as described herein is capable of supporting such provisioning for the reasons given herein. One of ordinary skill in the art could adjust the generated data infrastructure for any suitable art known system, including without limitation the systems listed above. As described herein, a “virtual machine” refers to any cloud based processor and associated memory.

The user interface may be created and deployed according to the user interface instructions. The user interface instructions provide a template which enables the user interface to be generated and then provisioned through the provisioned virtual machine. For example, the user interface may be operated through a user agent. The user interface may be created as code for operating a web app through a web browser as the user agent.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, a processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions - which can be a set of instructions, an application, software - which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1.A.i - 1.A.ii shows a non-limiting, exemplary method for automatically generating a cloud deployment of an application according to at least some embodiments of the present invention;

FIG. 1.B.i - 1.B.iv shows a non-limiting, exemplary data definition user interface;

FIG. 1.C.i - 1.C.vi shows a non-limiting, exemplary flow for data definition;

FIG. 2.A.i - 2.A.ii shows an example of an art known method;

FIG. 2.B.i - 2.B.iv provides a more detailed example of the art known method;

FIG. 3.A.i - 3.A.iv shows an exemplary output of specific infrastructure and interface instructions compiled from general templates (20) and unambiguous data definition (0);

FIG. 4.A.i - 4.A.iv shows an example of how a user interface template can be bound generically to data definition schema only, rather than to a specific business domain data concept;

FIG. 4.B.i - 4.B.iv shows a much more specific example of how the template presented in FIG. 4A would be determined, once converted from a “General Template (20)” to a “Specific User Interface Template (22)”;

FIG. 5.A.i - 5.A.iv shows a non-limiting, exemplary data schema including a bounded context according to at least some embodiments of the present invention;

FIG. 6.A.i - 6.A.vi shows a non-limiting, exemplary data schema in support of temporal state negotiation;

FIG. 6.B.1 - 6.B.iv shows how, within the exemplary data schema, the Primary Entity (1) and Association Entity (2) data types, which inherit from the exemplary “NegotiatedStateEntityDefinition” abstract concept, may be associated to multiple forms, which are distinct in terms of when a given form is relevant, rather than being distinct in terms of the conceptual role for the form;

FIG. 7.A.i - 7.A.vi shows a non-limiting, exemplary data schema with the definition of a Primary Entity (1);

FIG. 8.A.i - 8.A.vi shows a non-limiting, exemplary data schema with the definition of an Association Entity; and

FIG. 9.A.i - 9.A.vi show exemplary instruction and data flows.

FIG. 10.A.i - 10.A.vi show exemplary instruction and data flows.

### DESCRIPTION OF AT LEAST SOME EMBODIMENTS

The system and method, as described in at least some embodiments herein, relates to the configuration of data and management of same. From such a configuration according to data definition and a template, a software application may be automatically generated and deployed, and services may be automatically provisioned. A number of concerns arise when configuring data, which are addressed by the system and method as described herein. Some examples of such concerns are given below.

### Ownership

Ownership concerns include but are not limited to determining which entity owns the configuration data; whether such ownership is exclusive or shared; determining the owner on creation of configuration data and then after such creation, for example as part of a look up process.

### Payload Access Control

Payload access control concerns include but are not limited to enforcing permitted access to the configuration data by only the owner, or some other entity explicitly permitted by the owner. This situation is different from simple static endpoint access control. In this case, it’s not necessarily the right to access a service, but rather the right to transmit a specific payload, or a specific package of configuration data, to and/or from that service.

### Ownership Transfer and Negotiation

Ownership transfer and negotiation concerns include but are not limited to determining whether ownership can be transferred, and if so, which authorities or governing bodies may be involved; and the process for starting, negotiating and finalizing an update to configuration data or to that data’s owner.

### Storage

Storage concerns include but are not limited to determining how the data may be stored and retrieved.

### User Interface

User interface concerns include but are not limited to determining how the data may be presented to human users of the data management software application, for example in regard to visualization of the relationships between various collections of data; determining which elements of the user interface the user is able to see, for example based on what they own and their current level of authority within the organization that hosts the data.

### Attribution, Change Logging and Auditing

These issues are essential for shared data, and are generally also very important even for “single owner” data, to track the history of data over time. Correct handling of attribution, change logging and auditing may for example be useful in resolving disputes with regard to the current state of the data. It is also needed for data negotiation processes.

### Handling of Sensitive Configuration Data

Often configuration data is sensitive, such as for example personally identifiable information. Sensitive data may be protected through such measures as encryption at rest, encryption during transit, and rapid deletion or pseudonymization. In all such cases it is necessary to be able to easily identify this data so that it can be targeted for proper handling.

### Authoring Load

Authoring load concerns include but are not limited to optimizing processes in which large numbers of users manage large amounts of data concurrently, or otherwise handling heavy data loads during authoring processes.

### Consumption Load

Consumption load concerns include but are not limited to optimizing processes in which large numbers of users and/or processors consume the configuration data concurrently.

### Consumption for Processing

Processing consumption concerns include but are not limited to determining how data is to be fed to the applications that are to process it, and keeping processors of the data up to date.

### System Monitoring

System monitoring concerns include but are not limited to event logging, usage metrics, performance, debugging, support and alerting. For example such concerns may relate to monitoring the health of a data management system, determining whether a solution is meeting demand, the cost of meeting demand, and processes for addressing customer or data processor issues when the data is unavailable.

### Redundancy

Redundancy leads to resilience but may also be costly, such that redundancy concerns include but are not limited to minimizing the risk of data being unavailable or lost entirely.

### Infrastructure

Infrastructure concerns include but are not limited to provisioning hardware or virtualized hardware and service hosting.

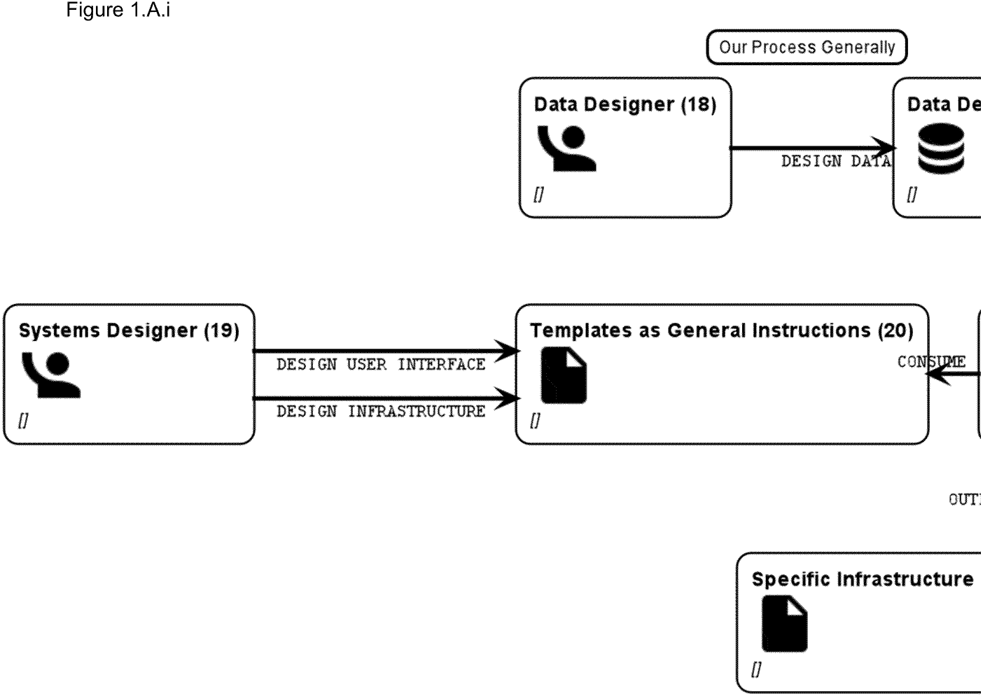

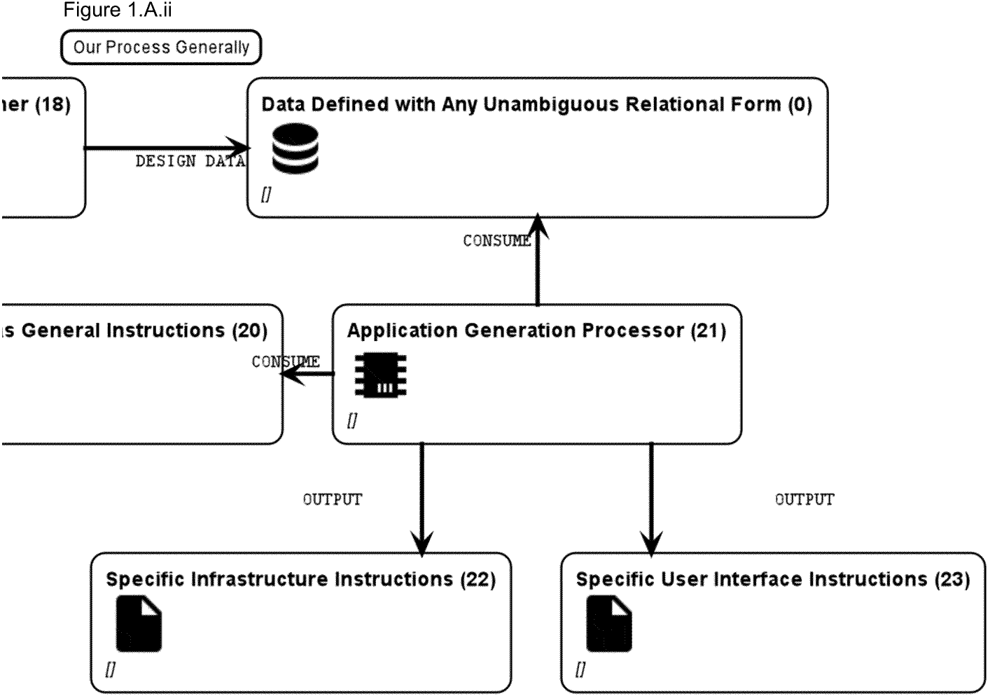

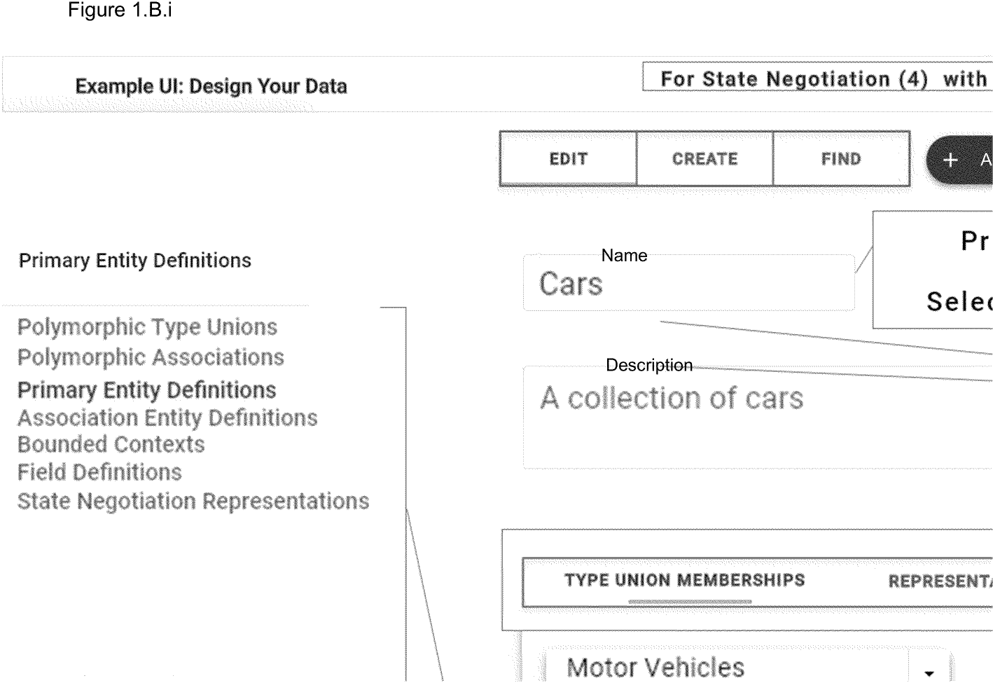

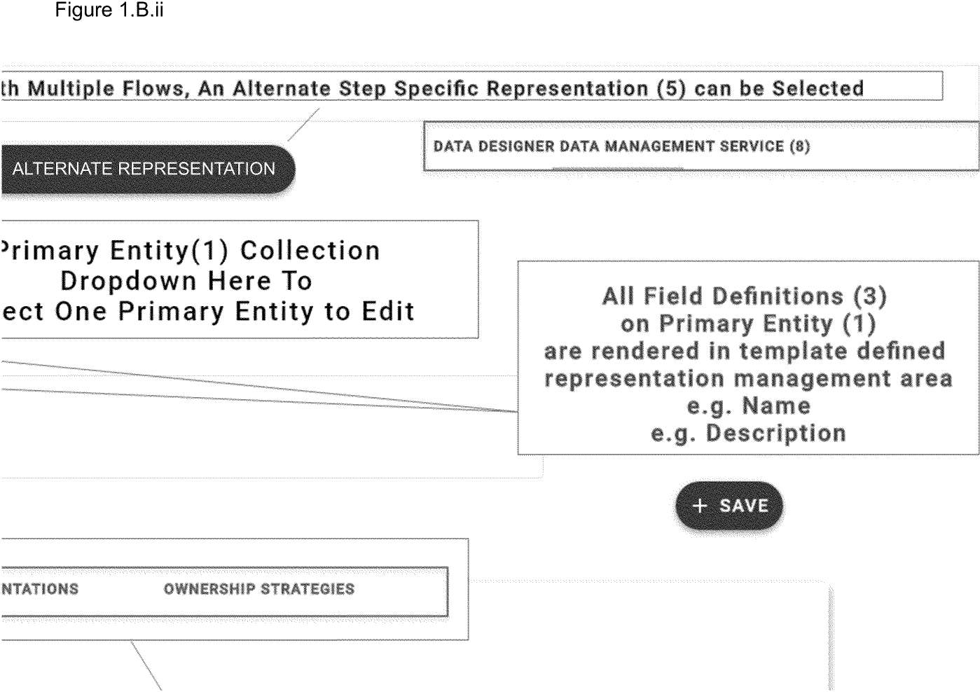

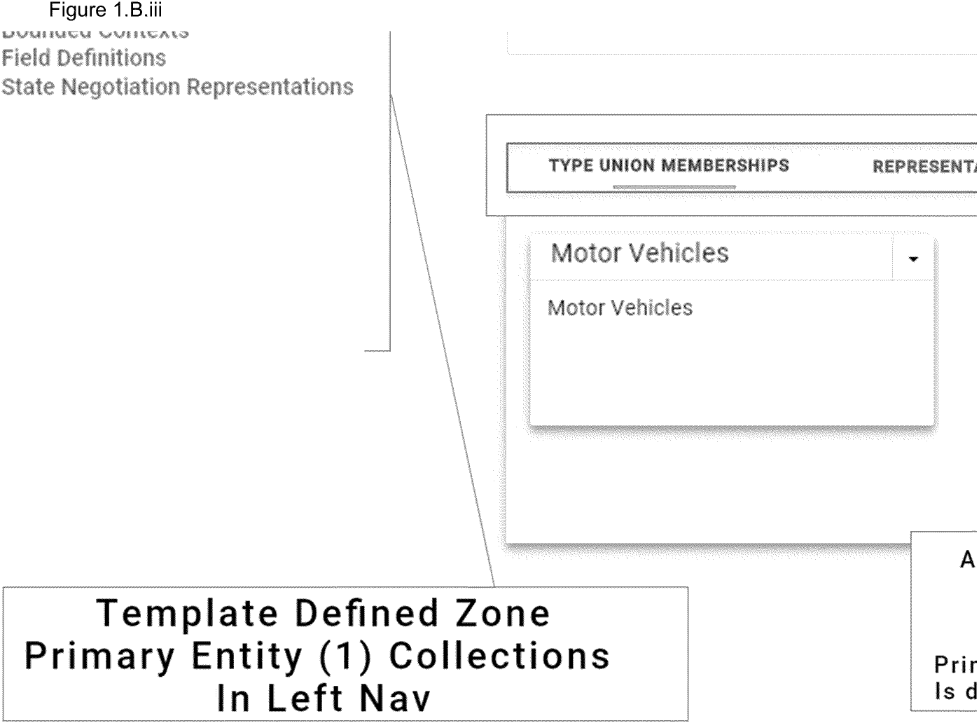

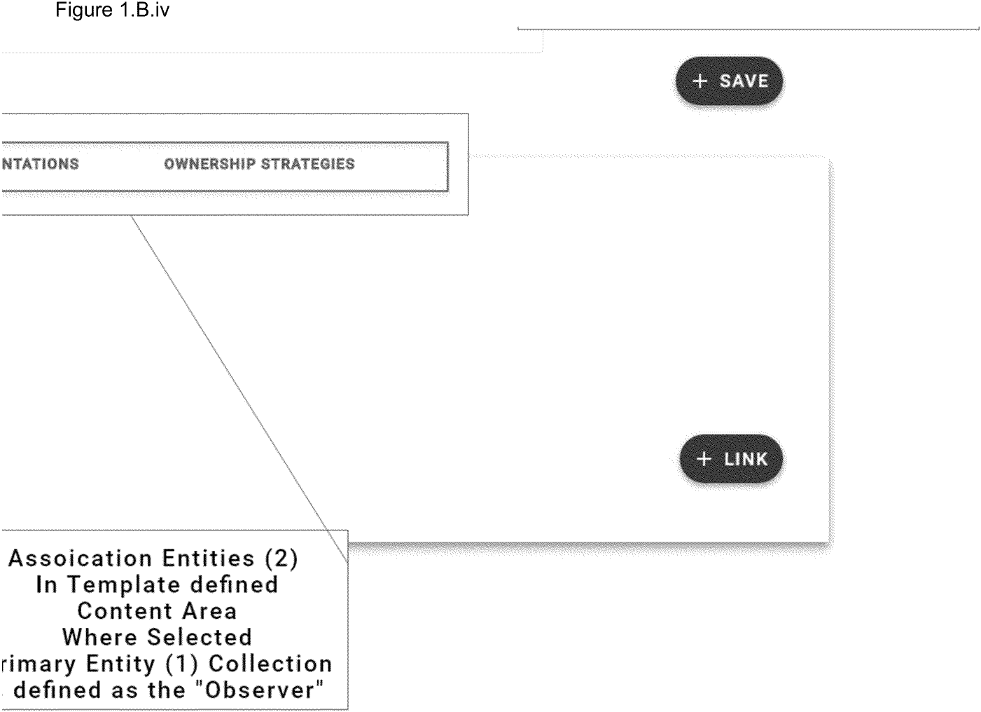

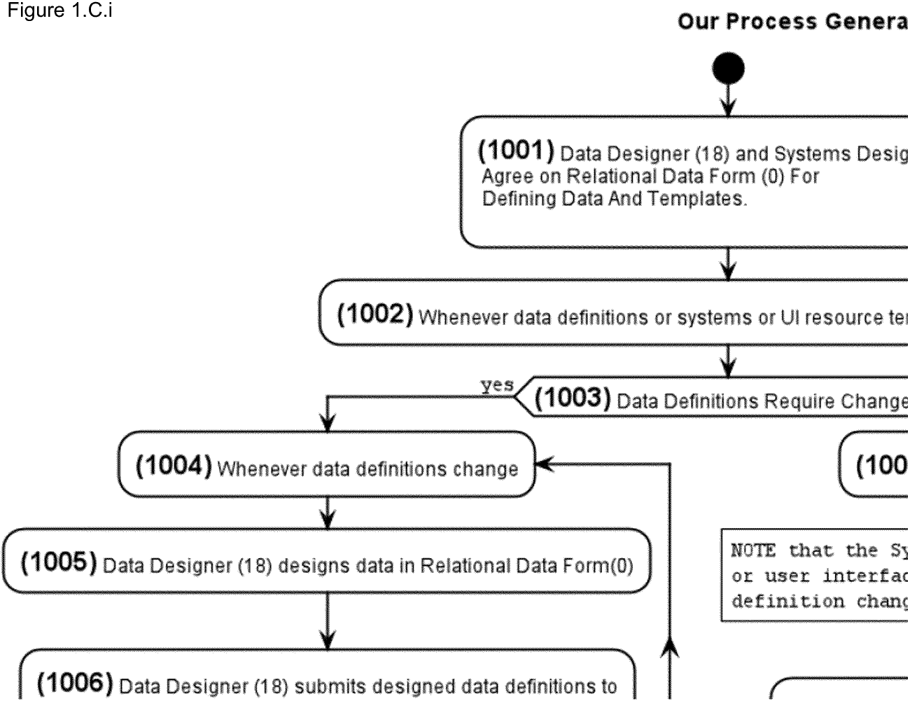

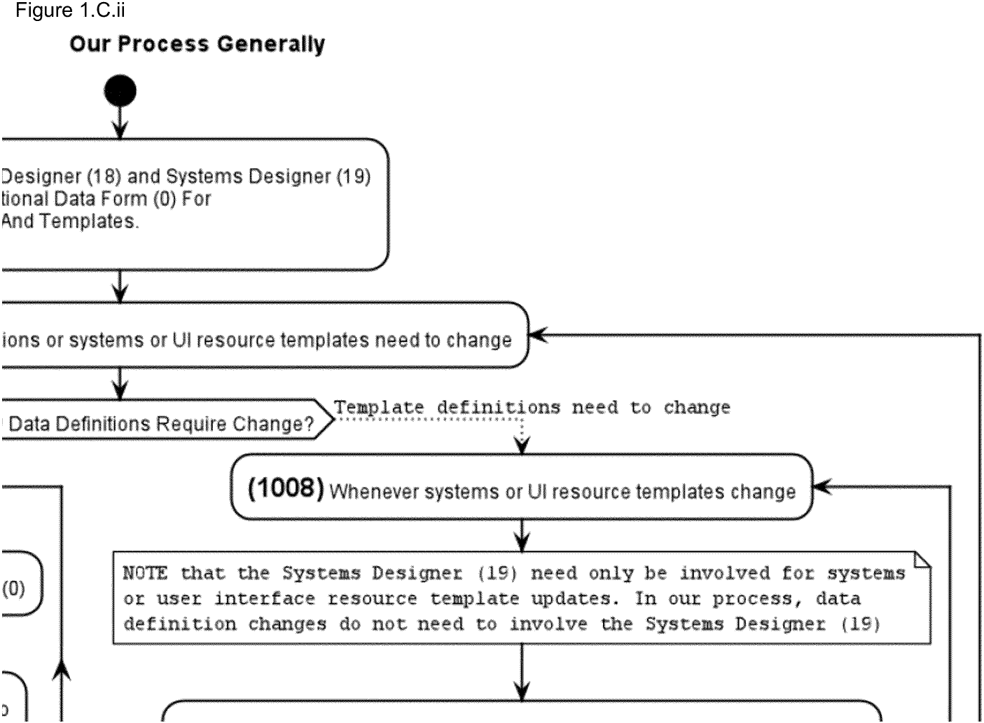

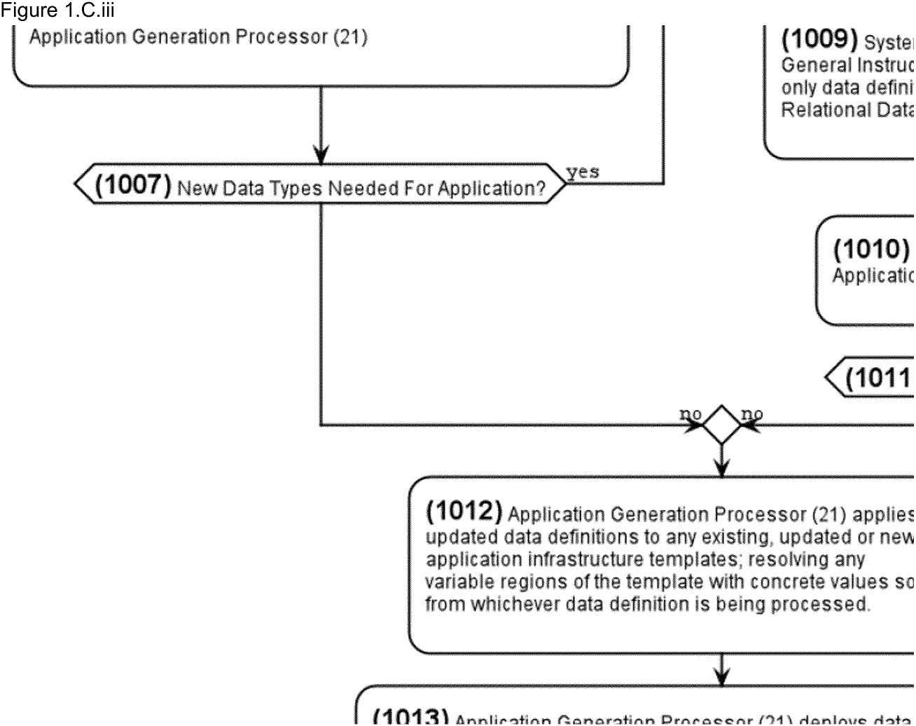

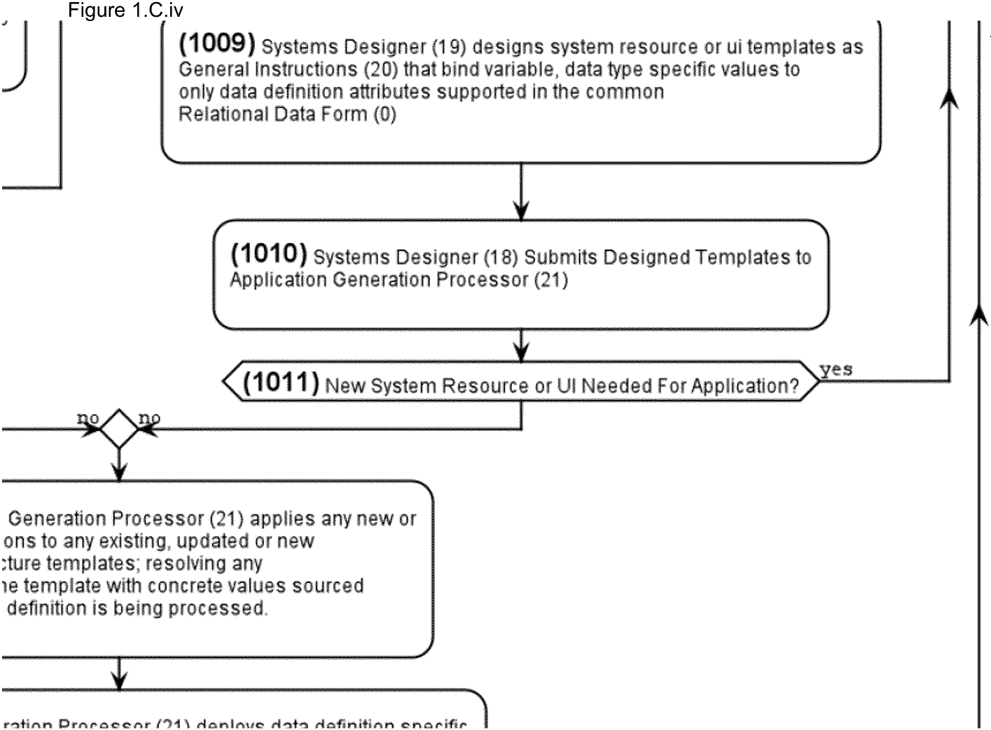

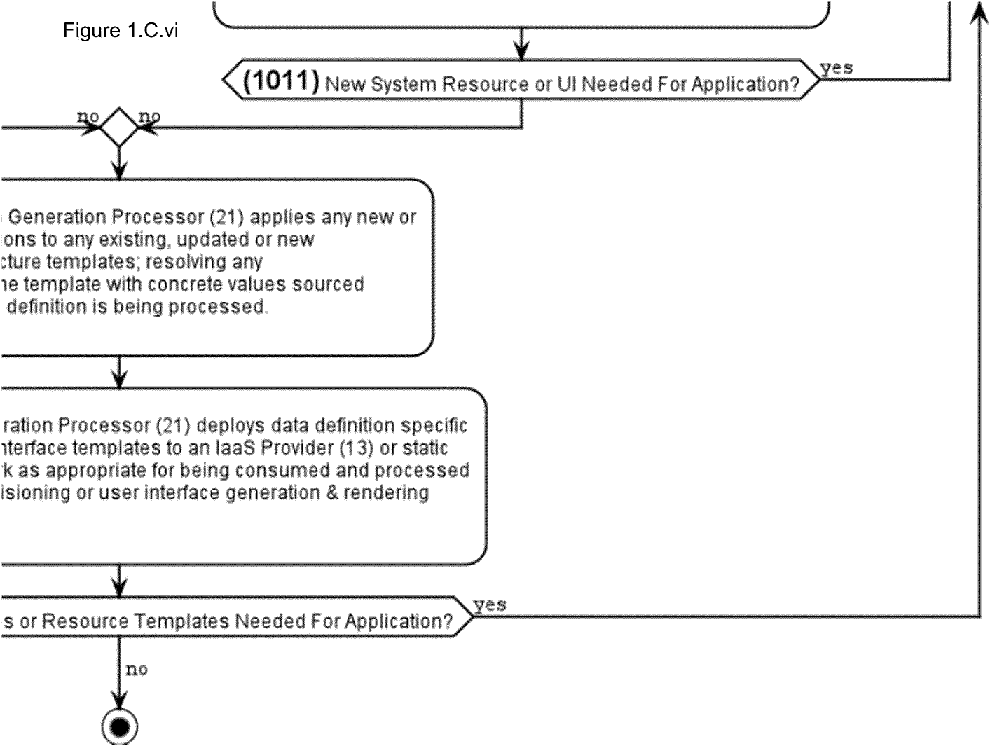

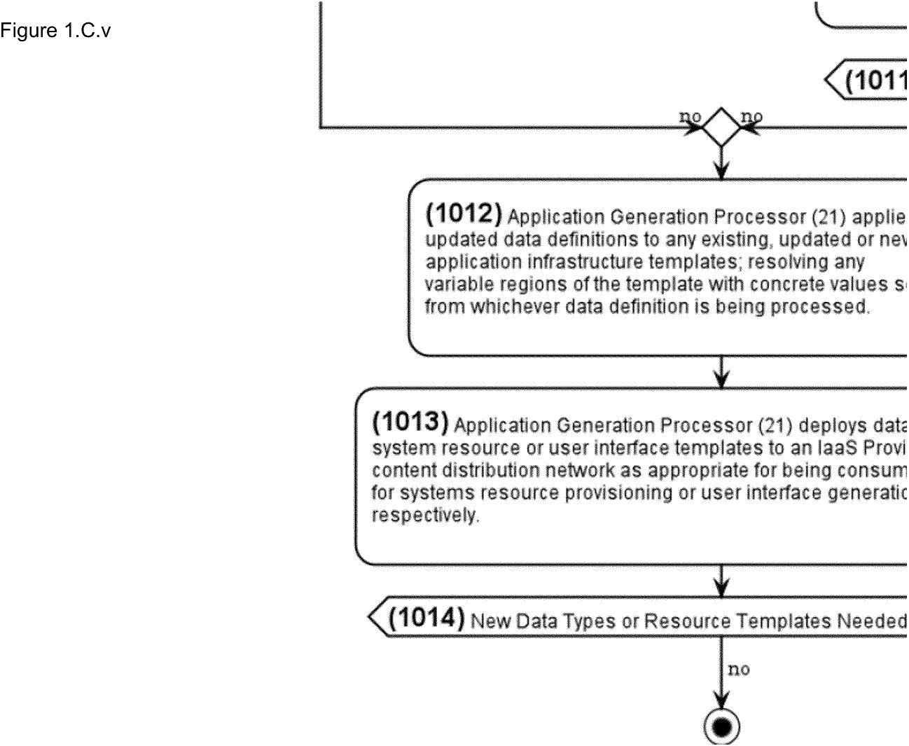

Turning now to the drawings, FIG. 1A shows a non-limiting, exemplary method for automatically generating a cloud deployment of an application according to at least some embodiments of the present invention. As shown, human inputs or inputs from a generalization system are provided separately with regard to the exact data design 18, as well as for a set of templates with general instructions for creating data infrastructure (20). The templates may be provided through a design process (19).

The data design is preferably provided as data defined according to any unambiguous relational form with abstractions at both ends (0). The relational data form generally describes the configuration data to be hosted relationally, in a schema or format which then supports the subsequent steps of the method. A set of fields, such as those described above for example, is preferably used to generate the necessary relational database column definitions and user interface controls. A non-limiting example of the relational data form itself is described above. Additionally, one or more templates are defined, as a set of templates for all resources to be produced. The Relational Data Form is preferably able to support template generation such that the templates are versatile, reusable and broadly applicable. The specific templates involved may vary. For example, if the deployment model features deploying to a mobile device with local storage or to a desktop computing environment with local storage, then templates are only required for those components that are being generated.

The two sets of inputs may be decoupled in time and may otherwise be asynchronous; furthermore, the inputs do not require an exchange of information, followed by further adjustments to either the templates or the exact data design. The general templates receive the data specification as inputs, to be able to create the specific data infrastructure. The relational data form and the general templates may be generated simultaneously or in any sequential order.

An example set of resources for a typical cloud service hosted data management application may be as follows. User interface templates may be defined with user interface areas designated for each of the abstract data entity types defined by the previously described Relational Data Form. Templates may be defined for data access services that support each of the abstract data entity types. Table definition templates may be defined for data database tables that support Primary Entities with one key and Association Entities with exactly two keys. User input control templates may be defined for any Field Definition types defined in the relational data model. These table definition templates may be incorporated into the user interface templates in an area designated for representing the state management area for a given Primary Entity definition or Association Entity definition.

Database column definition templates may be defined for any Field Definition types defined in the relational data model. These database column definition templates may be incorporated into the database table definition templates in an area designated for representing the column definitions for a given Primary Entity definition or Association Entity definition.

“Infrastructure as code” (IaC) templates may be defined for provisioning virtualized compute, storage and volatile memory resources needed to host the data access service components and data access storage.

The data infrastructure is created by an application generation processor (21), which outputs specific infrastructure instructions (22) and also specific user interface instructions (23). Application generation processor (21) comprises a computational device and may comprise multiple such devices. Application generation processor (21) may also comprise a plurality of cloud based processors and memory. As noted above, application generation processor (21) may operate through a supportive system of a hardware virtualization platform, as is known in the art.

One or more services are generated from the data definition. One or more data processors process the configuration data, for example to deploy a cloud based application. The data processors may for example be implemented through one or more computational devices, and/or through a plurality of cloud based processors and memory, and/or through a virtual machine as is known in the art. The term “deployment computational device” covers these various aspects of the data processors.

FIG. 1B shows a non-limiting, exemplary data definition user interface. As shown, a data designer can define the various business domain specific conceptual data entities, within the bounds of the data classifications defined and supported by the user interface and systems generation templates. The designed data features defined values for all required attributes in their definition, that all data to be supported by the generated application should have to satisfy the templates used for application generation. The user interface for defining this data preferably facilitates the population of all such data definition attributes, for example through a drop down menu that lists attributes to be defined and described.

This figure shows a non-limiting, exemplary, business domain specific value in the name and description fields of a new conceptual data entity being defined. The business domain specific data model referred to is that of a “Car” and this “Primary Entity (1)” is depicted in the process of being defined, with the name having just been entered in the name field as an attribute required in this exemplary data model, of all Primary Entities (1) in their definition. The actual business specific domain models defined can be for any concept, and the attributes required in the definition of these entities can vary.

An Association Entity (2) is described in the template defined content area, in which the selected Primary Entity (1) Collection is defined as the observer. Field Definitions (3) for a Primary Entity (1) are rendered in the template defined representation management area, such as those shown in this non-limiting example as name, description etc.

This figure also shows a non-limiting example of a Single Page App (7) user interface that can be generated from a data model defined using the above schema and descriptions. For this example, the generated UI presented is for the “data model defining” data model, such that the example UI would allow users to define other data models.

In this example, the user is able to select a Primary Entity to edit, for example from a drop down menu. The Primary Entity shown is “cars”. The user may also create or find such a Primary Entity. When editing the Primary Entity, all of the Field Definitions are accessible in a template defined representation management area. The definitions provided by the template support the correct interpretation of data; if the Primary Entity information were to be provided in another manner (other than through this exemplary user interface), the definitions would still need to be observed and correctly filled for the template to ingest the data definition properly.

For State Negotiation with multiple flows, an alternative step specific representation may be selected for one or more flows, to determine alternative actions optionally with alternative fields.

The user is also able to interact with a data designer data management service, which supports the definition of the data design.

The Association Entities to the Primary Entity “cars”, such as “motor vehicles” may be selected according to Type Union Memberships, in which an Association Entity is indicated as being associated with the Primary Entity. The selected Primary Entity Collection is defined as the Observer.

FIG. 1C shows a non-limiting, exemplary flow for data definition. As shown, at 1001, the data designer and system designer agree on a relational data form (0) for defining the data and templates. At 1002, when a change is required, for example to a data definition, system and so forth, then at 1003, it is determined whether the data definitions do require change. If that is determined at 1004, then at 1005, the data designer creates a new or updated data design in the relational data form (0). At 1006, the data design is submitted to the application generation processor (21). At 1007, it is determined whether any further changes are required, and if so, the process returns to 1004 for further processing.

At the other branch, if a change is required to some other aspect, then at 1008, it is determined whether such a further change is required. While the system designer is preferably involved in these changes, the system designer is preferably not required for any data definition or related changes.

At 1009, the system designer may design this new change, for example in relation to a system resource or UI template. Such a change may further include general instructions (20) that bind variables, data type specific values and so forth to data definition attributes supported in the relational data form (0).

At 1010, the system designer preferably submits the change(s) to the application generation processor (21). At 1011, it is determined whether any further changes are required, and if so, the process returns to 1008 for further processing.

At 1012, after the above changes are made, the application generation processor (21) then executes any required changes.

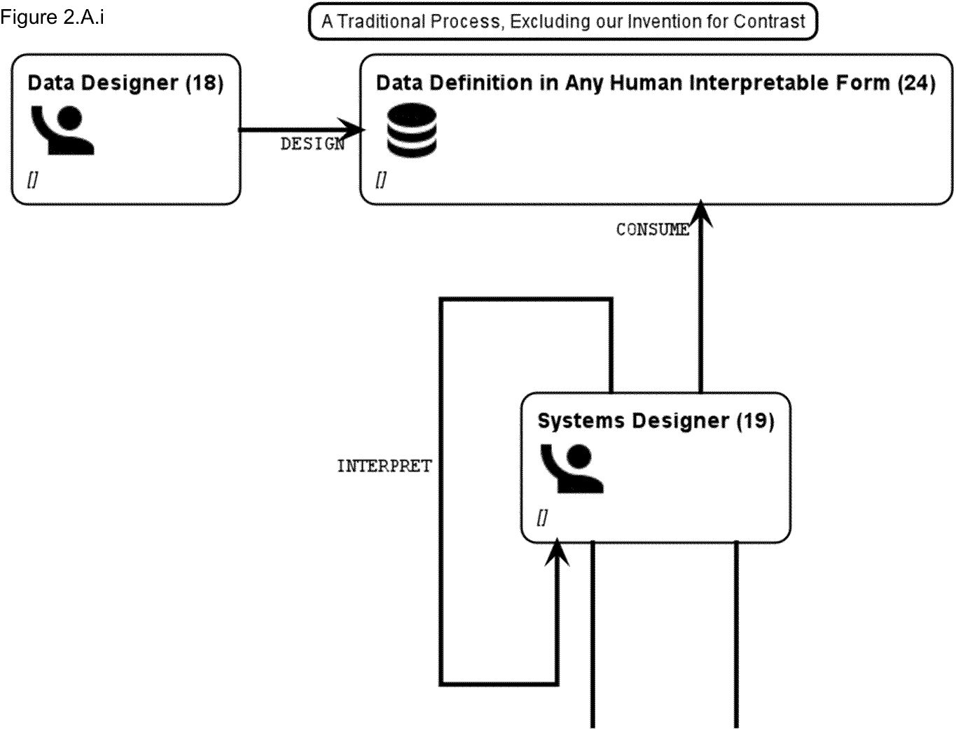

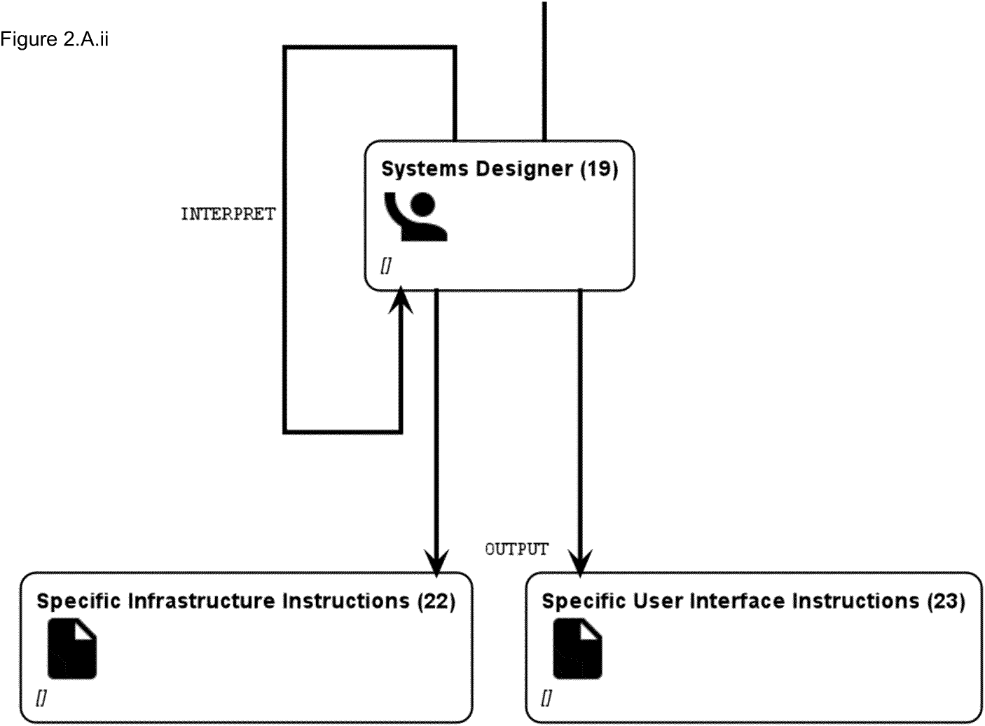

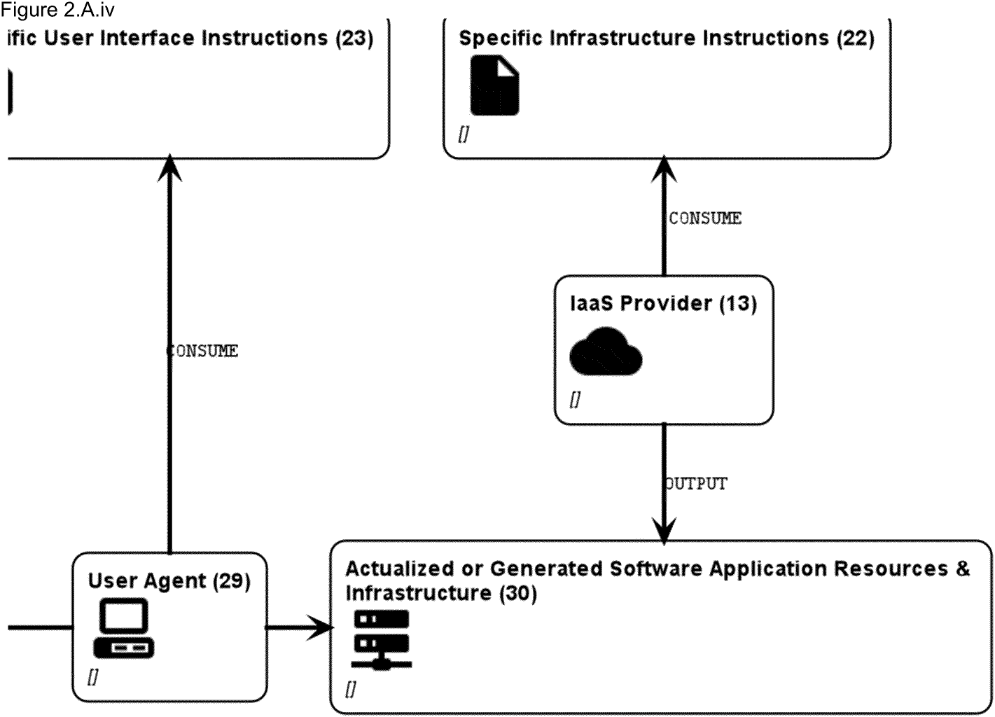

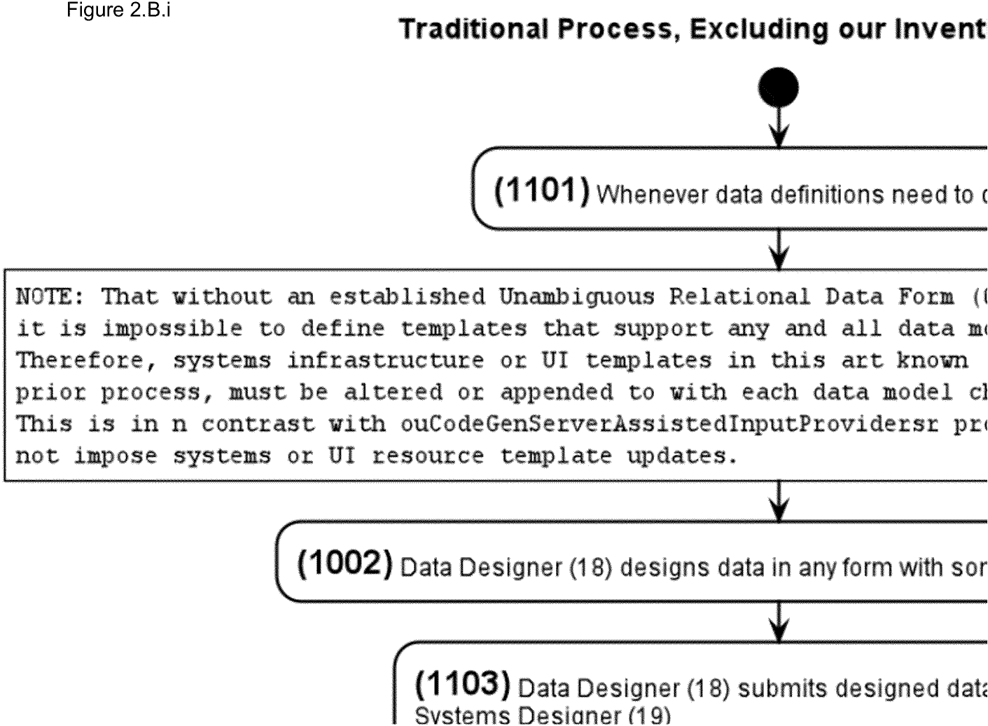

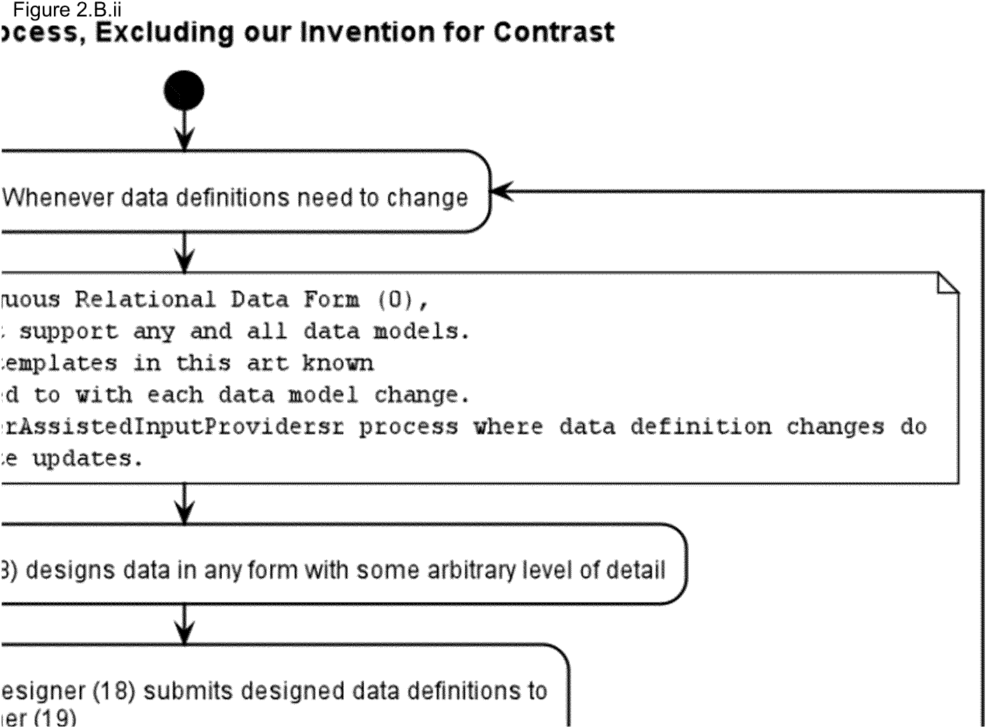

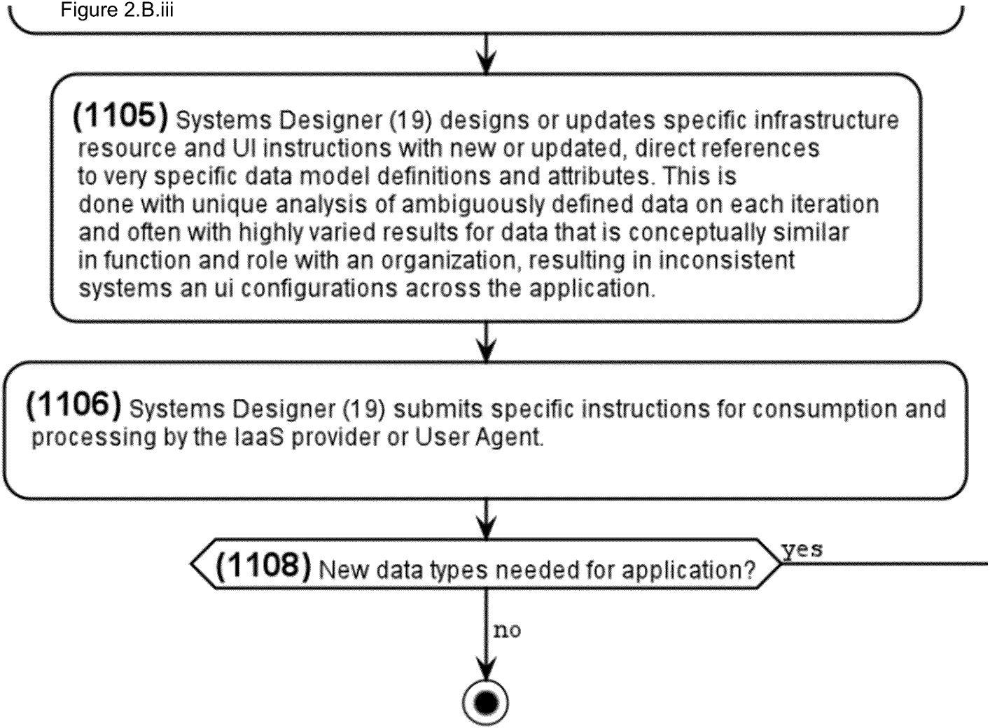

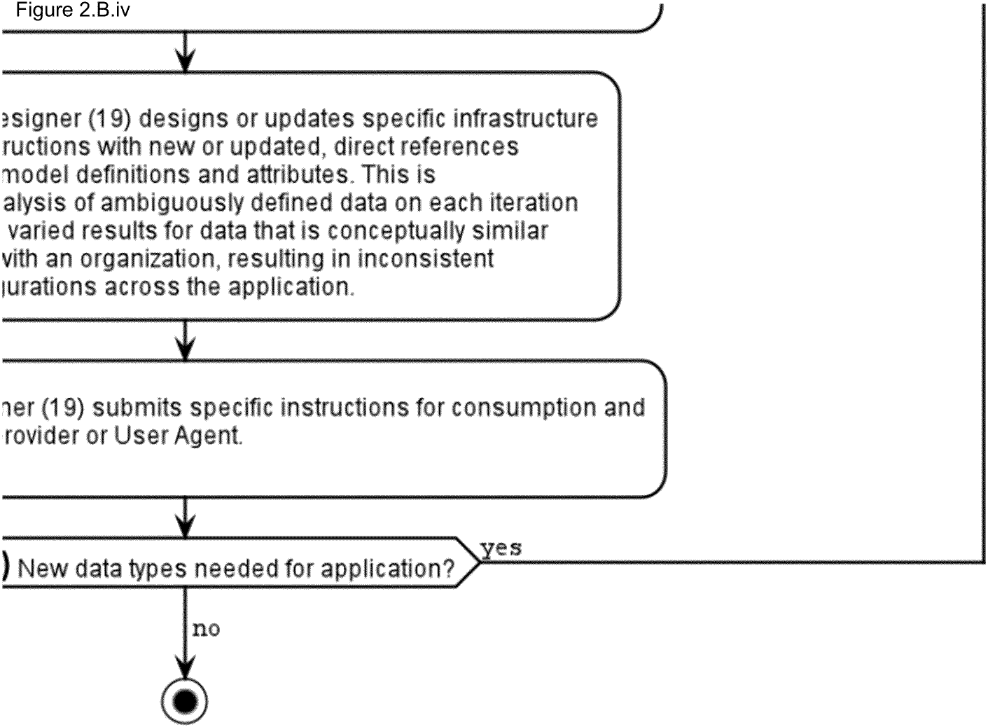

FIG. 2A shows an example of an art known method, which in contrast to the inventive method of FIG. 1A, requires a repeated cycle of multiple human inputs. Furthermore, a review and exchange of information is required, followed by additional adjustments to the data design before infrastructure and user interface generation instructions can be created. This process requires additional time and also requires tightly coupled communication between the data designer and the infrastructure engineer. As shown, a data design process (18) produces a human interpretable set of data definitions (24), which by their very nature are not standardized, nor are they standardizable. A system design process (19) then interacts iteratively with data design process (18), with the human designers and developers interacting with each other extensively. This manual process outputs specific infrastructure instructions (22) and also specific user interface instructions (23).

FIG. 2B provides a more detailed example of the art known method. At 1101, whenever a change is required, the data designer must make the changes manually at 1102, and then submit them at 1103. At 1104, the system designer must interpret these changes, update the data model, and consider the effects on the system overall. These actions must be taken sequentially, as the system designer needs to wait for the data designer to finish their work. Furthermore, for FIG. 1C, the data designer and system designer may be human, AI or automation based, or a combination thereof. For FIG. 2B, only humans are available to fulfill the roles of data designer and system designer, because this work is performed manually. This necessitates further slowdowns and reduced work output.

At 1105, the system designer actually performs the system design update work. This work must be performed manually, and so requires time and human resources to do. At 1106, the system designer submits these changes. A further human review is required at 1107 to determine if additional changes are needed, further slowing down the process.

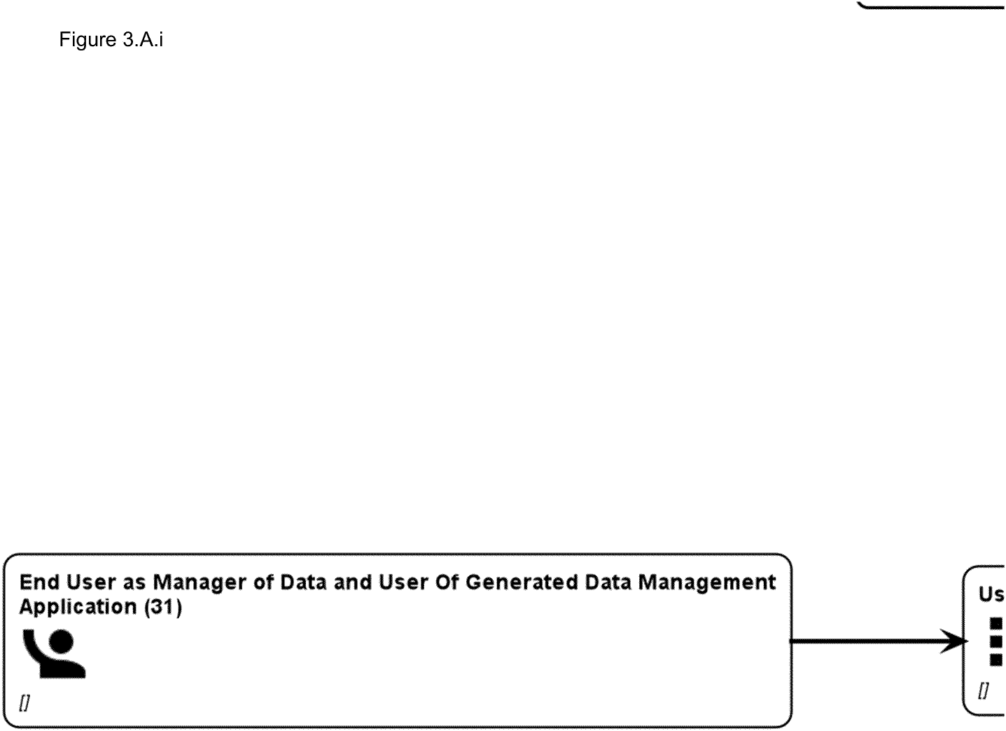

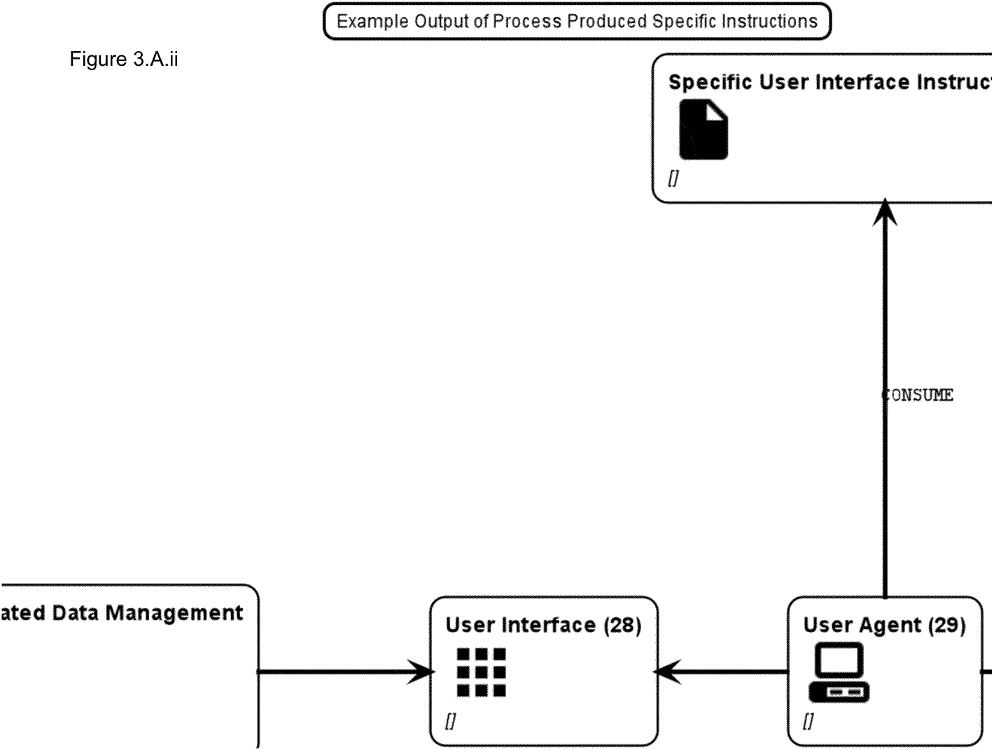

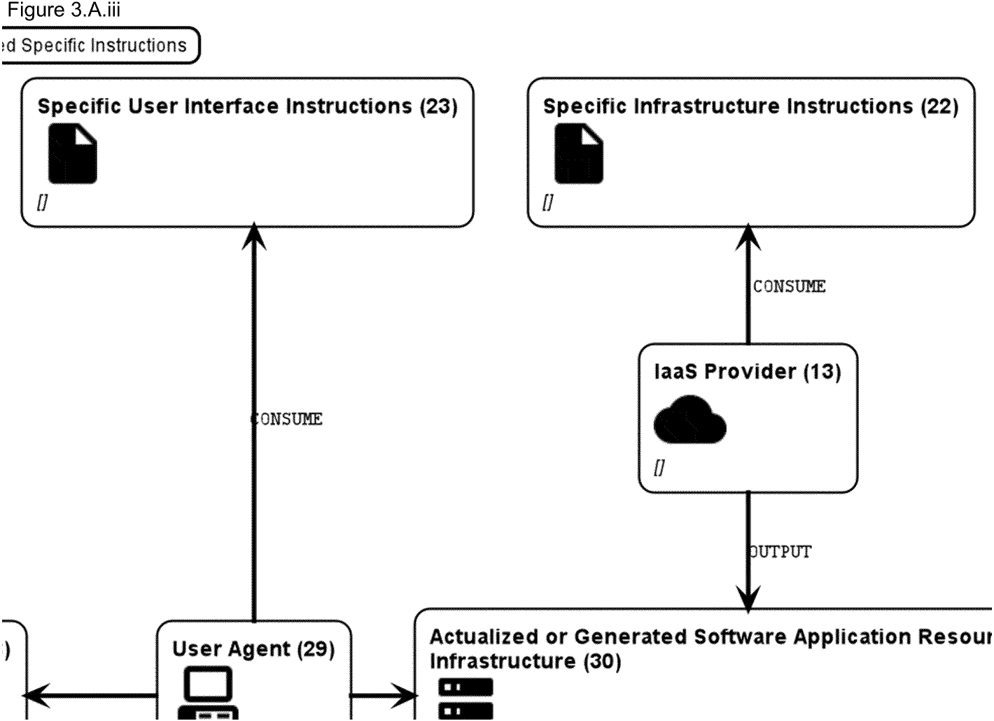

FIG. 3 shows an exemplary output of specific infrastructure and interface instructions compiled from general templates (20) and unambiguous data definition (0). The outputs are produced by an exemplary output instruction flow, in which the outputs from the method of FIG. 1A are received, with regard to the specific infrastructure instructions (22) and also specific user interface instructions (23). The user interface instructions (23) are then used to create the user interface, through a user agent (29). A non-limiting example of such a user agent (29) may be a web browser for example. For example, the user interface instructions may comprise the code necessary to support a web app, or software application interface provided through a web browser.

The infrastructure instructions (22) are used to create the actual application infrastructure (30), for example through an IaaS (Infrastructure as a Service) provider (13). Infrastructure (30) may also include the generated software application. The end user computational device is then able to provide the user interface (28), to display data and commands, and to otherwise interact with the application.

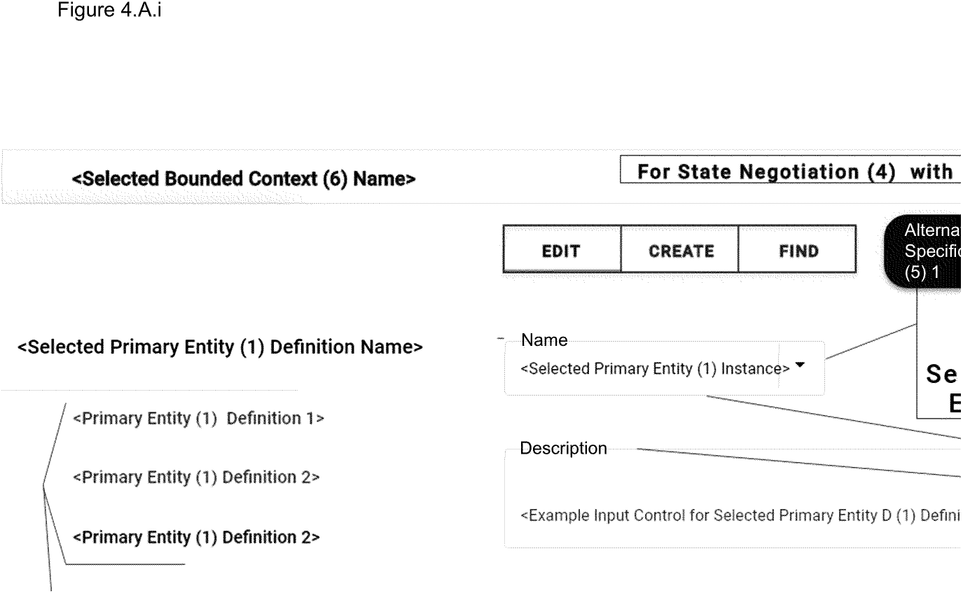

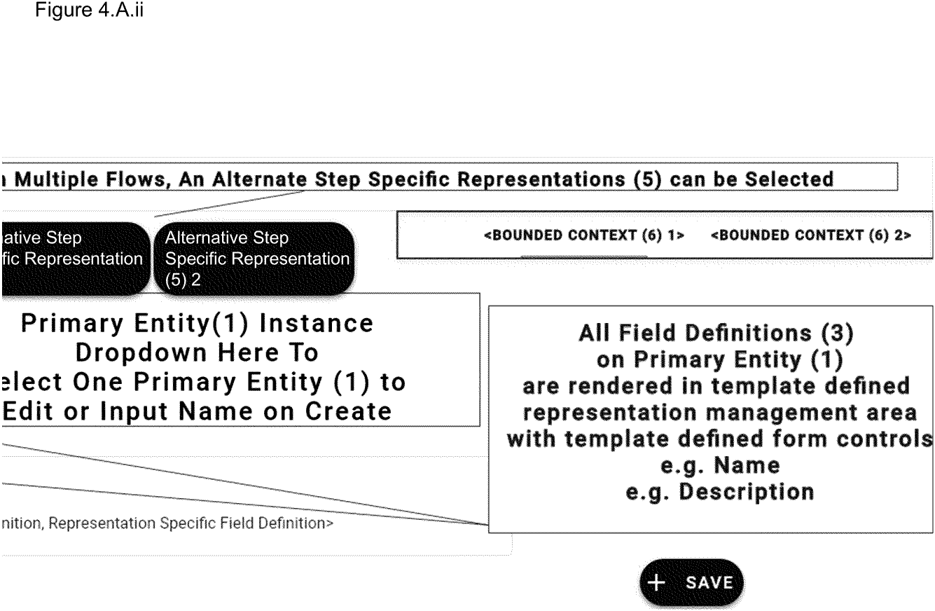

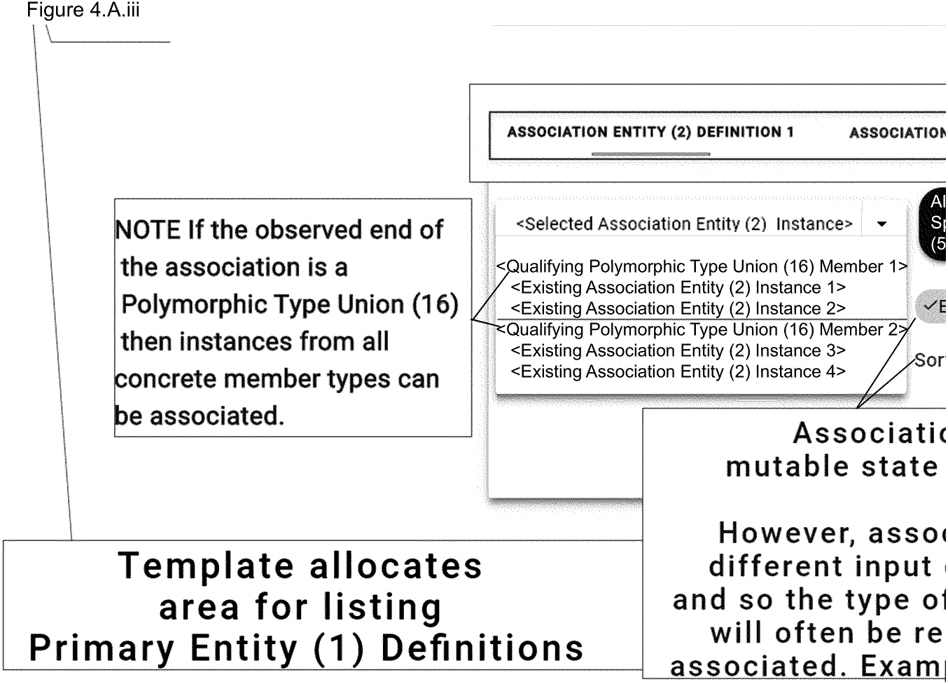

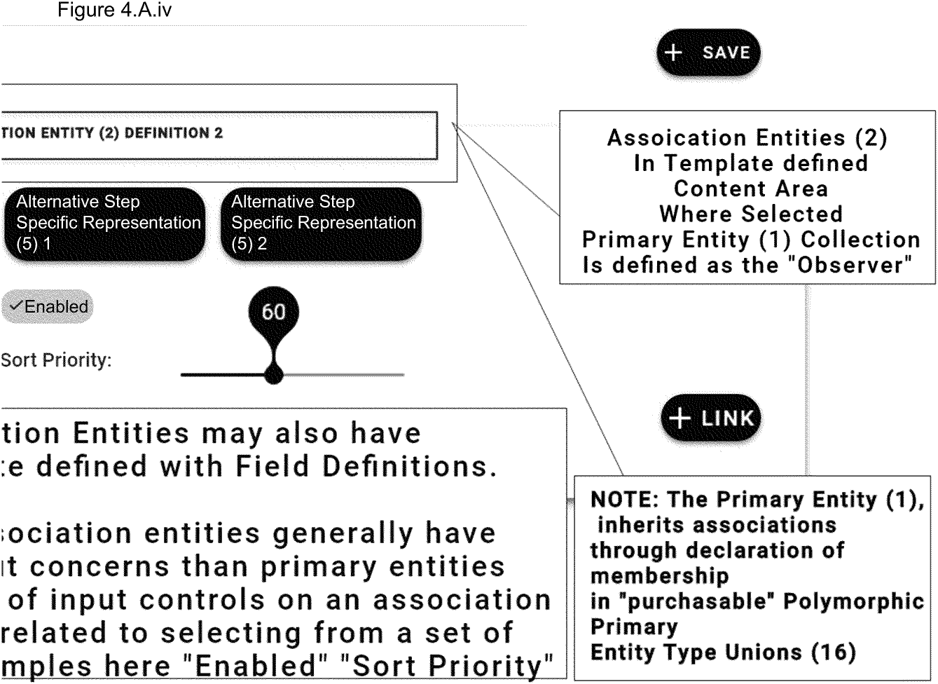

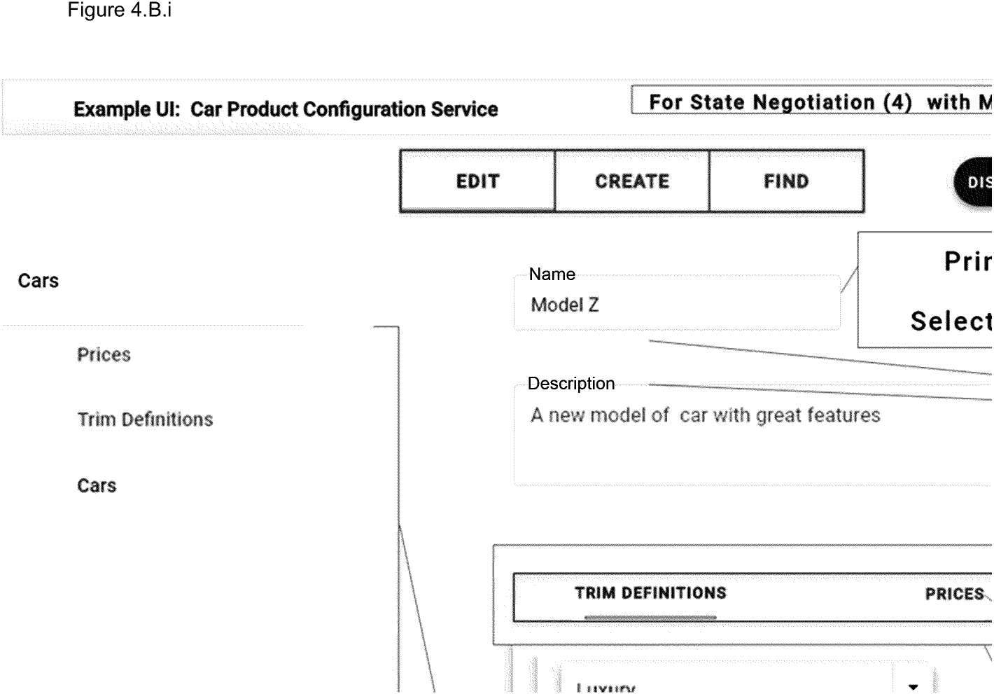

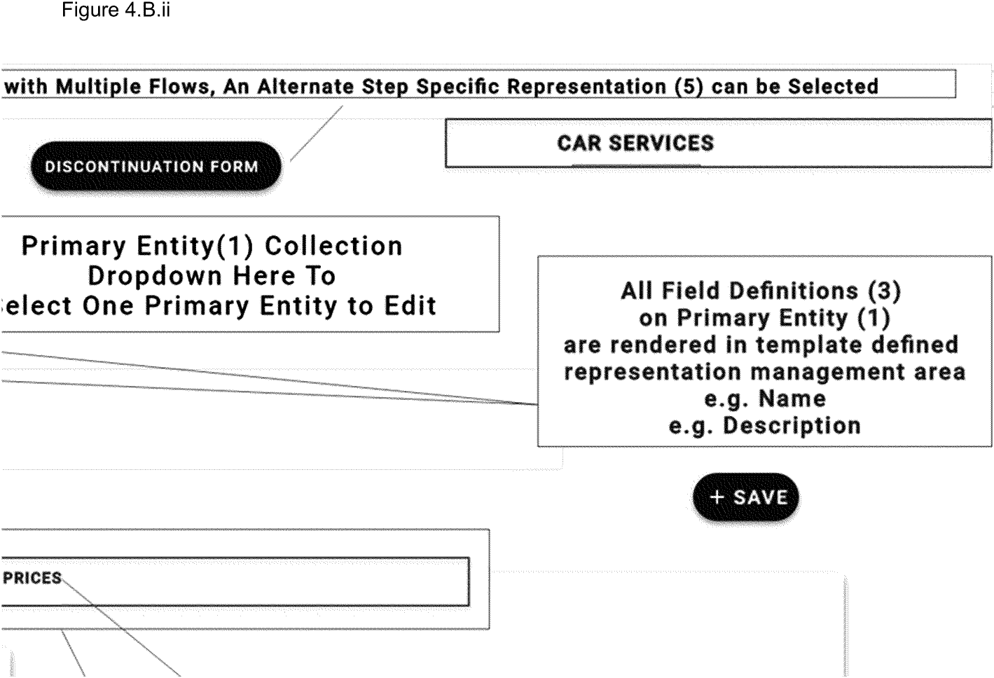

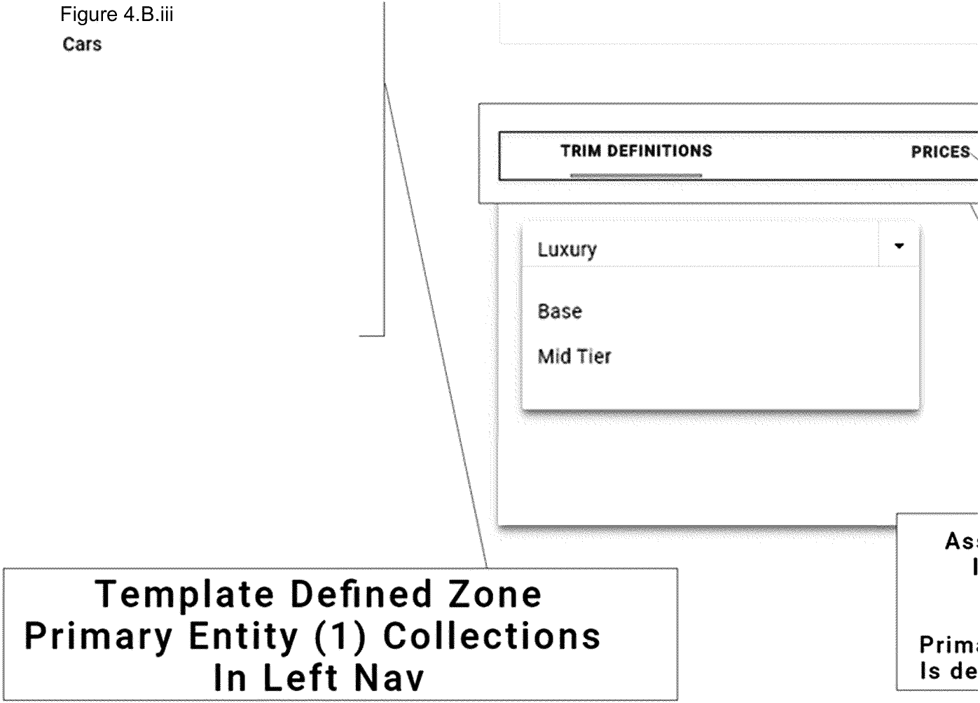

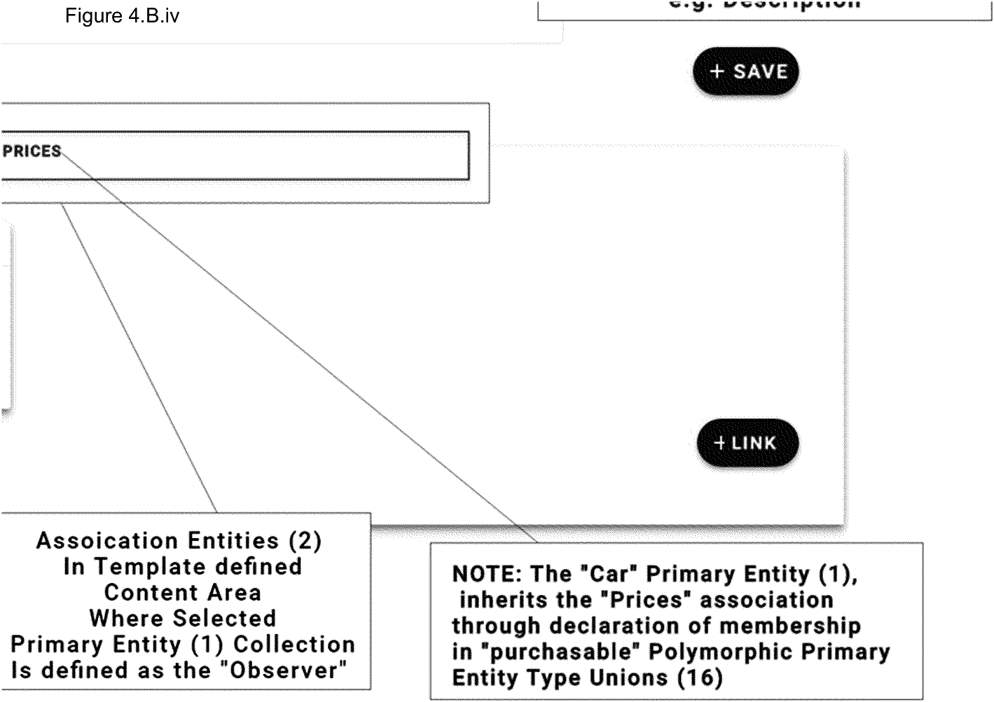

FIG. 4A shows an example of how a user interface template can be bound generically to data definition schema only, rather than to a specific business domain data concept. This strategy of binding regions of the UI (user interface) template to the schema used to define data, rather than to the business specific data directly, is what allows for the template to be made portable, re-usable and stable. By stable, it is meant that the template can remain unchanged and yet still functional, across multiple iterations on, or changes to, a business domain data model. This stability allows the data model to change and grow without obligating the systems designer to update their systems designs between data definition updates.

A number of the components shown in FIG. 1B are shown here in more detail, as an example only. Details are shown with regard to the Primary Entity (1), which in this non-limiting example inherits associations through definitions of membership in the business concept of “purchasable”, as applied to Polymorphic Primary Entity Type Unions (16). Association Entities as shown may have a mutable state, defined with Field Definitions. Association Entities may have different input concerns than Primary Entities, such that the type of input controls as shown in this example may be differently determined. For such Association Entities, if the observed end of the association is a Polymorphic Type Union (16), then instances from all concrete member types may be associated.

FIG. 4B shows a much more specific example of how the template presented in FIG. 4A would be determined, once converted from a “General Template (20)” to a “Specific User Interface Template (22)”. The conversion may be performed by populating the dynamic or variable regions defined in the template, with the corresponding, appropriately typed, grouped or defined entities within the business domain specific data model. In this example the business domain is one that relates to configuring the commonly known concept of a car. One of the singular conceptual data entities or “Primary Entities (1)” that the data designer has chosen to define is a car. Therefore the car, being designated as a Primary Entity (1) by the data designer, is bound to the area in the template designated for Primary Entities (1), without any further interpretation needed on part of the user interface or systems designer.

The capacity to support automatically, and with complete accuracy and consistency, the proper placing and positioning the newly defined conceptual data entity, in this case, known as a “car”, into the UI without involving the user interface designer, is a major focus and benefit of the present invention, without wishing to be limited by a closed list. This can be accomplished without the template incorporating any prior reference to the concept of a “car” because the concept of a “Primary Entity” serves as an intermediary between the definition of the UI template and the definition of data, allowing for automatic translation or mapping between concepts defined by the data designer and concepts defined by the systems or user interface designer. The data designer has a contractual obligation to consistently categorize or define their data in an “unambiguous (0)” and standardized way. This standardized structure used to define new data concepts is then used by the user interface or systems to define regions in the UI for such designated data. Again, for clarity, if the user interface designer and data designer can agree on the definition of a classification or categorization of data, such as the shown exemplary “Primary Entity (1)” construct, then the template designers for both systems infrastructure and user interfaces, can build around these abstract classifications or categories, allowing the data designer to concurrently, or even in advance, design any number of concrete, business domain specific data models, without involving the interface or systems designers. These features allow the user interface template to be designed and finalized before the data that makes up the contents of any given category is defined to populate that region of the template.

For example, a left navigation area may show a set of template definitions for a Primary Entity (1). One Primary Entity (1) is edited at a time, selected from example through a dropdown menu, along with the Association Entities (2) as described above. The “car” Primary Entity (1) in this non-limiting example inherits the “Prices” association through declaration of membership in “purchasable” Polymorphic Primary Entity Type Unions (16), demonstrating how the template enables a standardized data structure to be implemented.

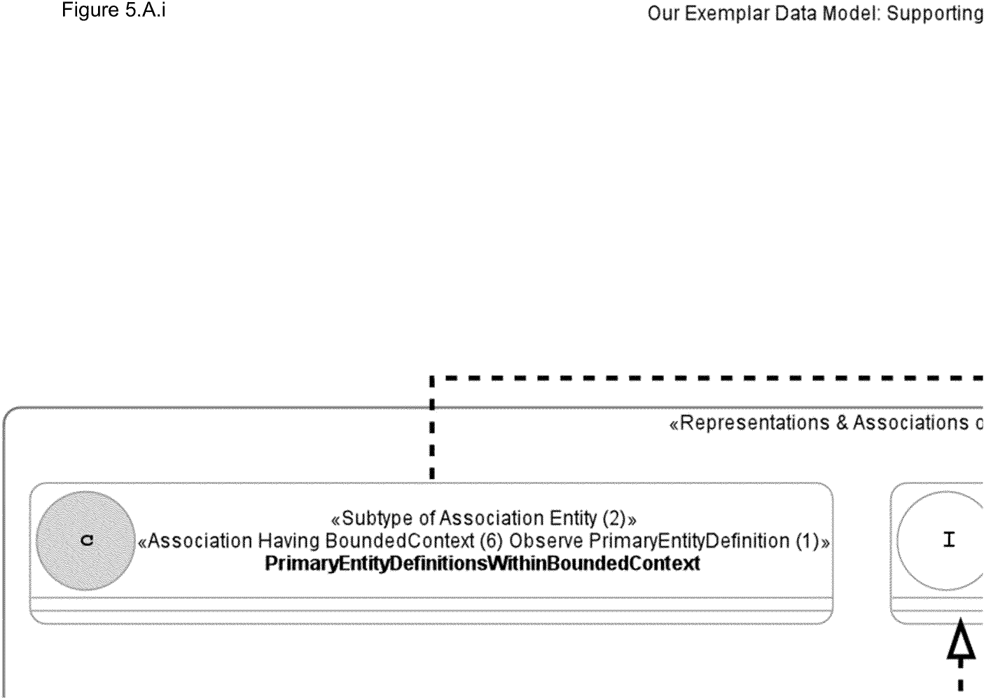

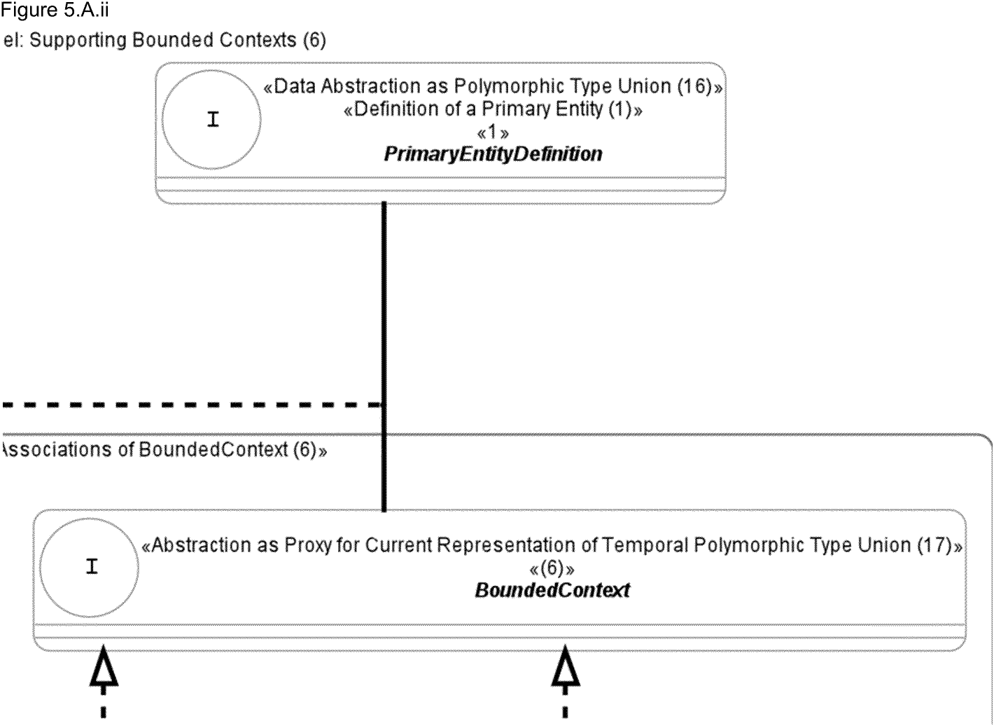

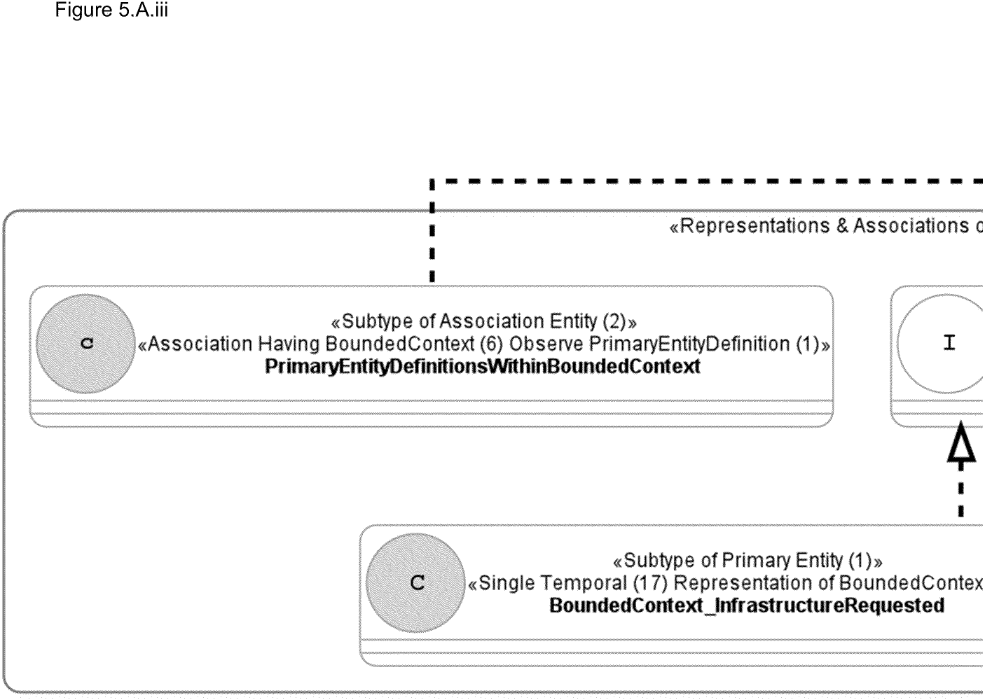

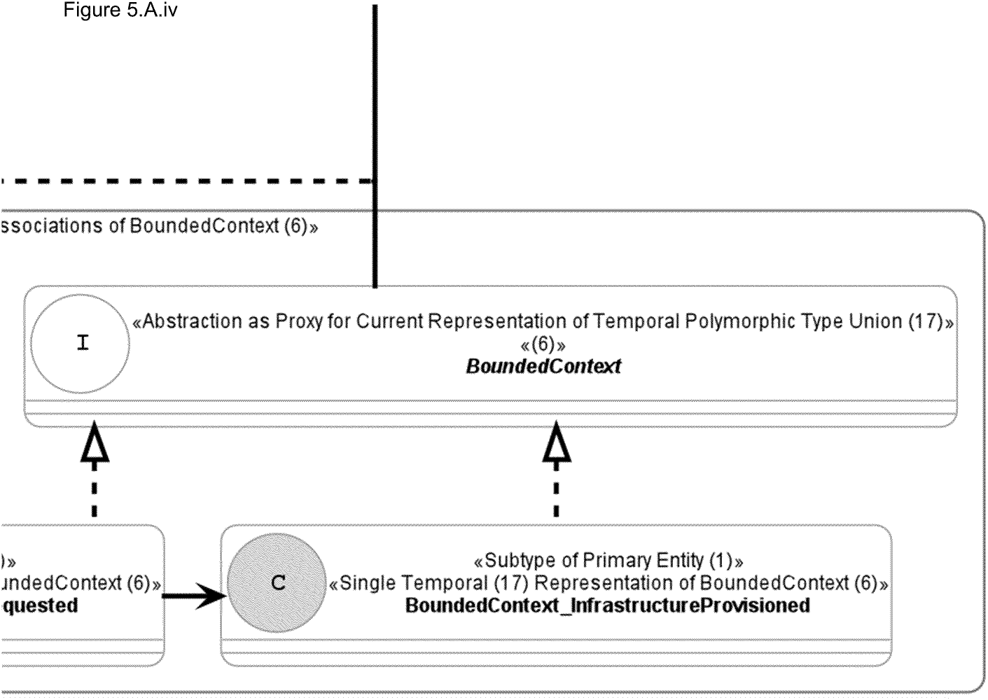

FIG. 5 shows a non-limiting, exemplary data schema including a bounded context according to at least some embodiments of the present invention. A “bounded context” is a grouping of conceptual data entities that share common concerns in terms of interaction and volume of use due to their close relation to one another. If more processing capacity is to be allocated to support one of the data entities within this business defined bounded context, then that same capacity change should be assumed to be needed for the other data entities in that bounded context as they may generally be loaded and managed in the same user session. Optionally, some generated applications may not require the definition of bounded contexts. While the relational data form used should ideally support explicit definition of bounded contexts, it is not strictly necessary to do so according to at least some embodiments of the present invention.

In the exemplary data schema shown herein, the conceptual data entities within the bounded context are defined as “Primary Entities” for data that represents a singular concept and “Association Entities” for data that represents a relationship between multiple singular data concepts. Concrete examples of “Primary Entities” and “Association Entities” could include what is commonly known as a “car” and a “car ownership” respectively. In this example the car is a “singular data concept” as well as is a person which is a candidate for taking the owner role in the association. The “car ownership” is an association between a car and a person as “ownership”, where data may exist on that “Association Entity” that is independent of both the car, and the owner. Such association specific data may for example, include the date at which ownership took effect. This is data that is not applicable to the existence of the owner and is not applicable to the existence of the car, but applies only to the existence of the relationship between car and owner.

In this exemplary data schema, the singular data concepts and associations between them are defined with instances of Primary Entity Definition or Association Entity Definition respectively. Optionally “Associations” may not exist in the absence of the data concepts that can be associated. For example “Car Ownership” has no meaning if the concept of a car does not exist or if the concept of an owner does not exist. Therefore, an association entity may exist only after two or more conceptual data entities or “primary entities” also exist. Importantly Associations connect two or more conceptual data entities and so cannot be included within a bounded context, without excluding one or more Primary Entities involved in the association, unless all primary entities pertaining to the “Association Entity”, and in fact, it follows, all of their transitive associations, are included in the same bounded context. If one end or the other of the association is not allowed to be excluded from the grouping of data entities, then it may be expected that all data in the business domain is required to be included in a singular bounded context, through transitive inclusion of associated data.

In order to successfully break apart a business domain into multiple bounded contexts then, rules should ideally be applied to do so consistently. Again consistency and clarity in the data model is essential to the definition of reusable templates. These reusable templates are the key to allowing an engineer to design infrastructure once, for any and all data models, rather than being obligated to be involved in every and all future design iterations on the data model. Therefore, in the exemplary data model, an “observer” may be defined as the primary entity in the association, to which the association is to be co-located with regard to a bounded context. If the primary entity is placed into a grouping, such as a bounded context, where associations should be included, then only the associations that list the primary entity as the “observer” in the relationship, are to be included. This tolerance of co-locating only a subset of the associations that involve a given Primary Entity, where the subset selection is defined in a consistent way, allows the business domain’s conceptual data model to be consistently broken apart in a standardized way, where consistency in data definition is again, as stated, critical to supporting the definition of re-usable application generation templates.

Note that in the exemplary data schema, selection or designation of an “observer” as the primary entity on one end of the association, with which the association entity should share a common bounded context, may be imperfect and in some cases it may even be arbitrary. Preferably, as shown in the exemplary data model, the important factor is the designation of the observer. Preferably, the designation be clearly stated in how the data is defined. The goal when selecting an observer is to select the primary entity as the observer, where the selection of the primary entity produces the smallest number of associations included for that type of association. However, a sub process for reliable selection of one end of any association, as the ideal end to be designated as the “observer”, has not yet been established. Again, perfect selection of the observer is not important in the exemplary application of the process as described herein. It is only important that the primary entity on one end of any association is defined as the end known as the “observer” where being the observer, simply means that this is the primary entity at one end of the association with which the association entity should share a common bounded context. Of note, these associations also share a user interface context with the primary entity deemed the observer. If managing a primary entity, all associations that list that primary entity as the observer, are then rendered in the same user interface context and maintained in that same context. Note that the definition of bounded contexts as well as the designation of an “observer” in data associations is not critical to the process. These two aspects of this exemplary form allow for breaking down large business domains into smaller working contexts, but this is not essential to the generation of an application interface and infrastructure. Breaking down large business domains is important for maintainability of such domains, but not essential for generation.

As shown, the exemplary data schema relates to a data model (6) with a bounded context. A Primary Entity Definition (1) and an Associated Entity Definition (2) are provided. Primary Entity (1) is associated with a set of representations and associations of the bounded context (6). A subtype (17) of the Primary Entity Definition relates to a single temporal representation of the Bounded Context.

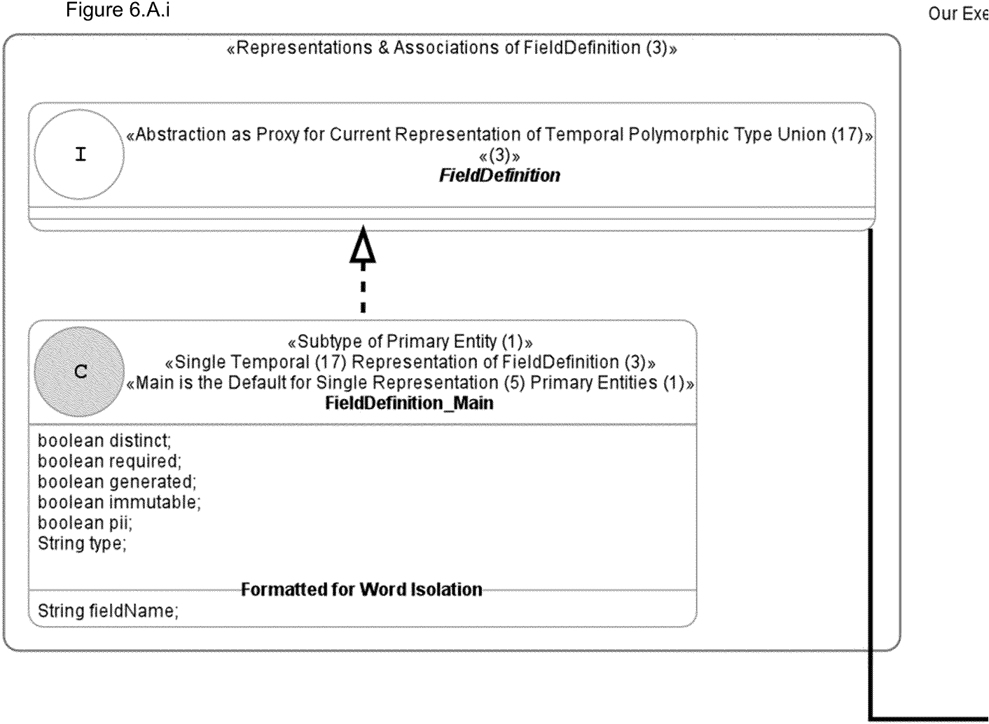

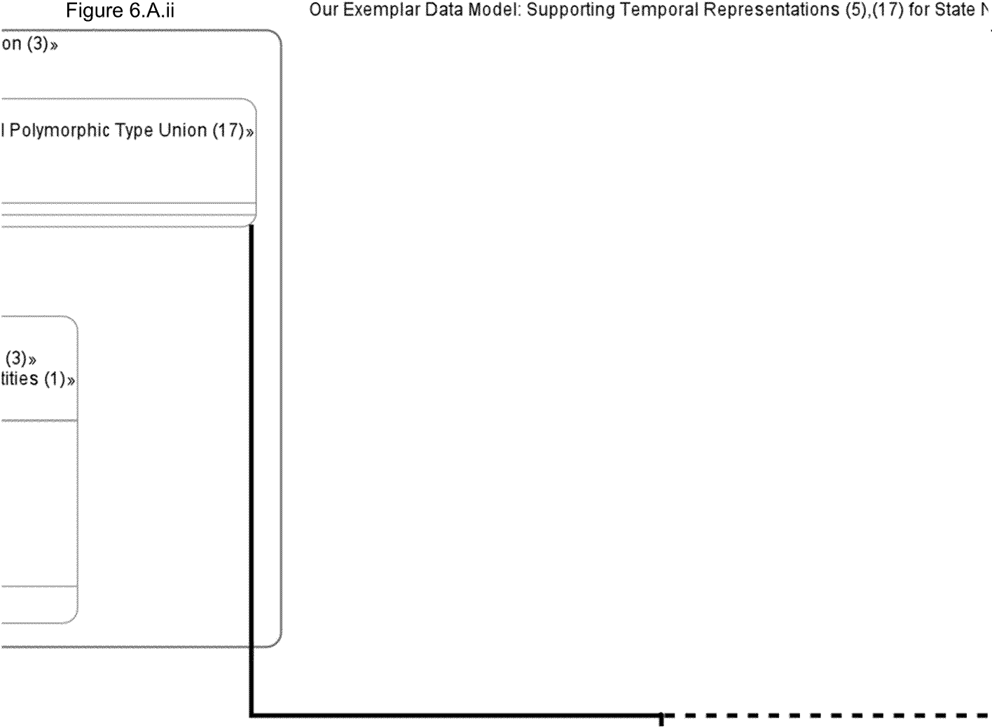

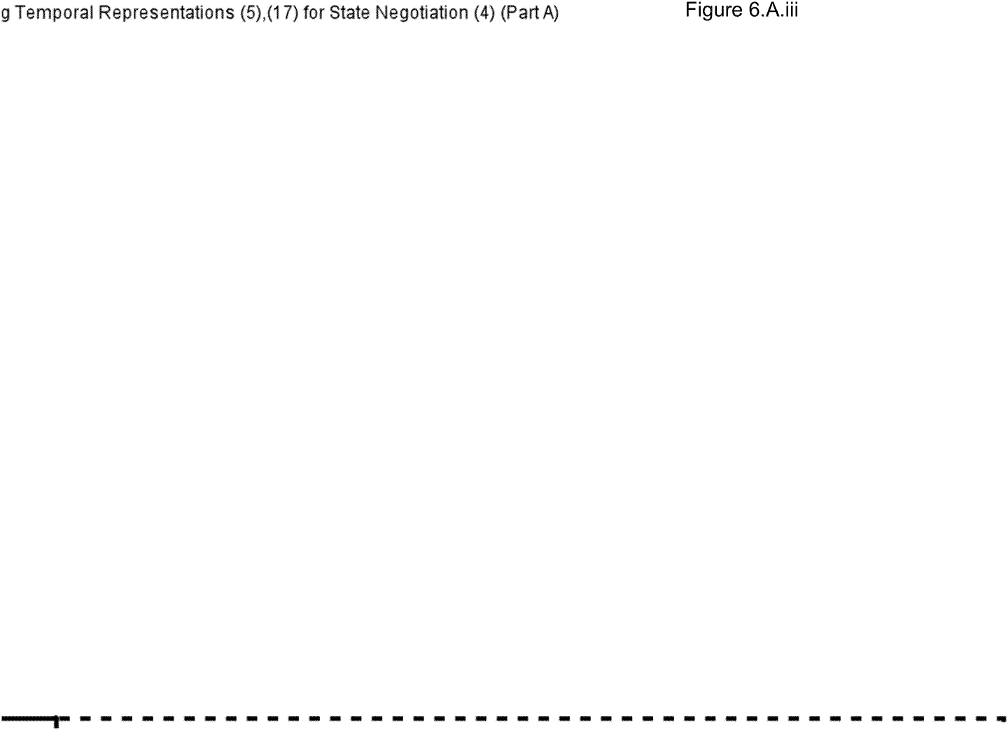

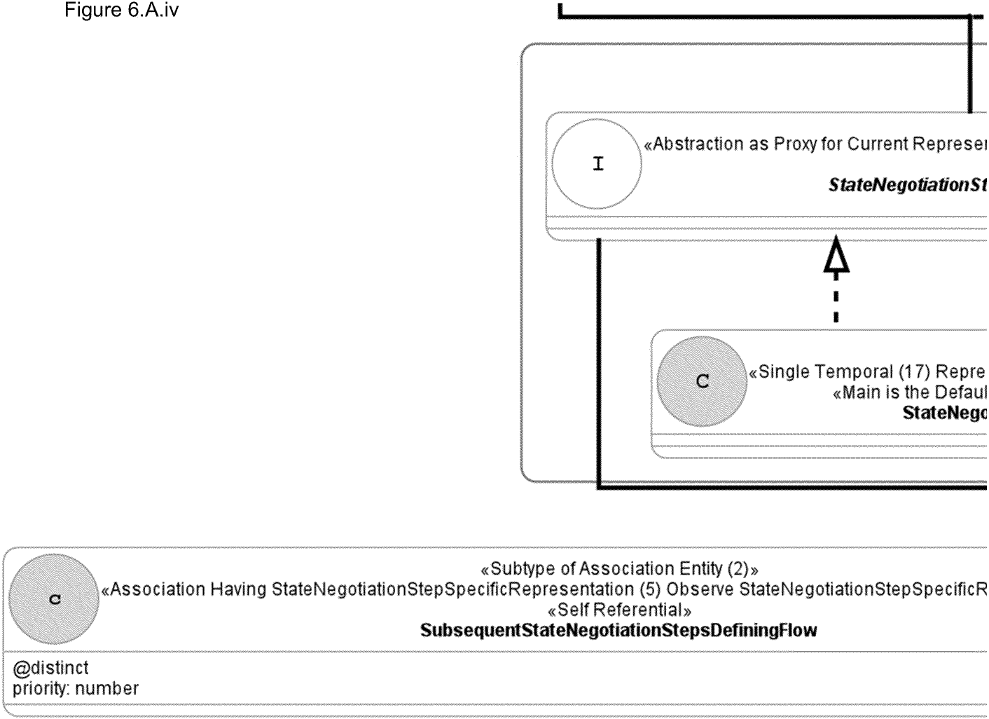

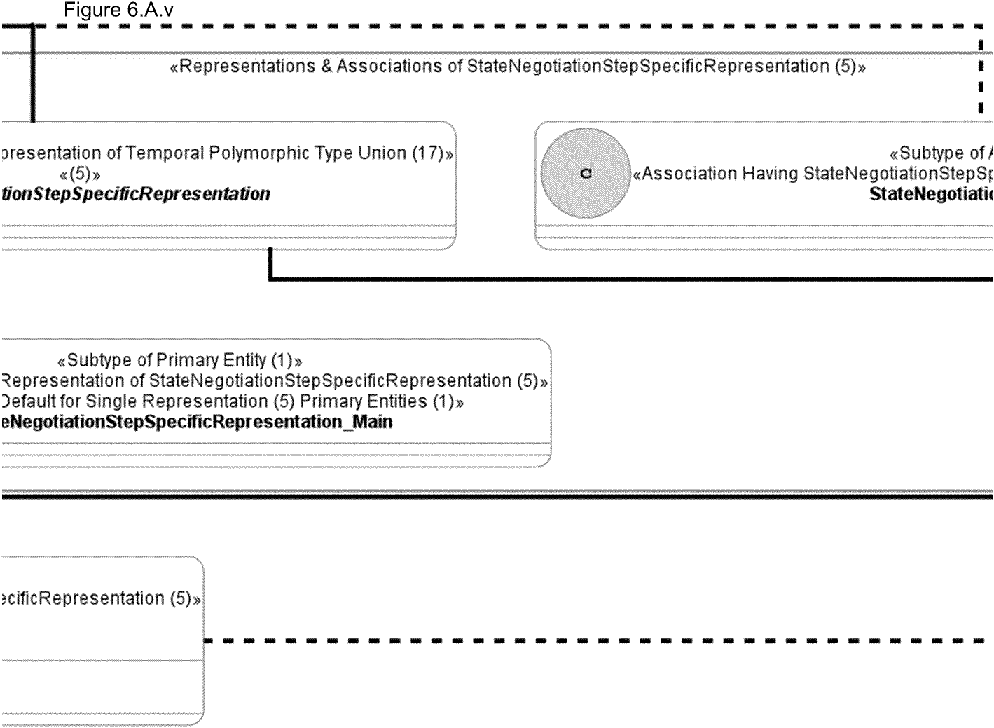

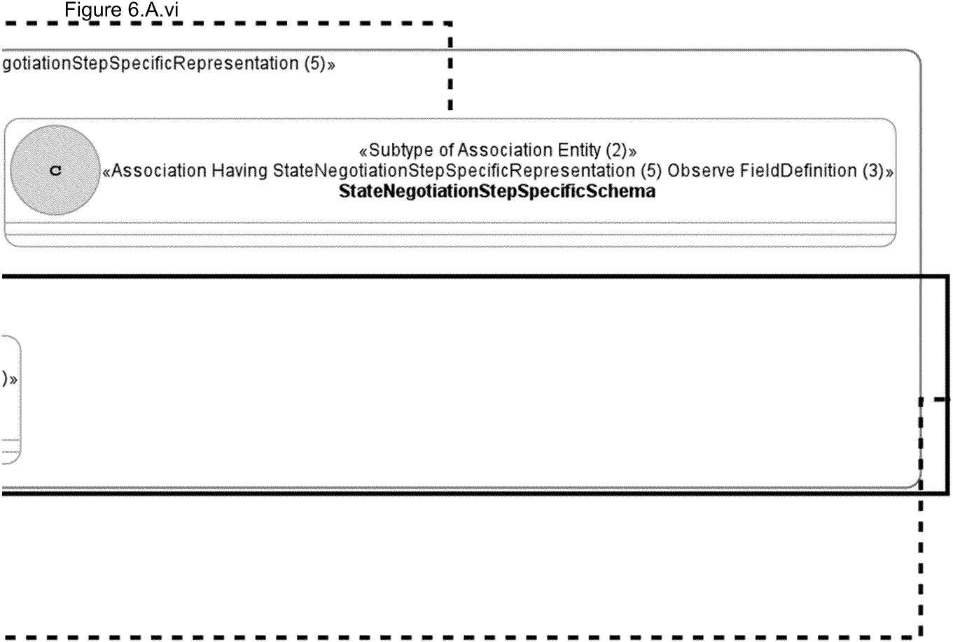

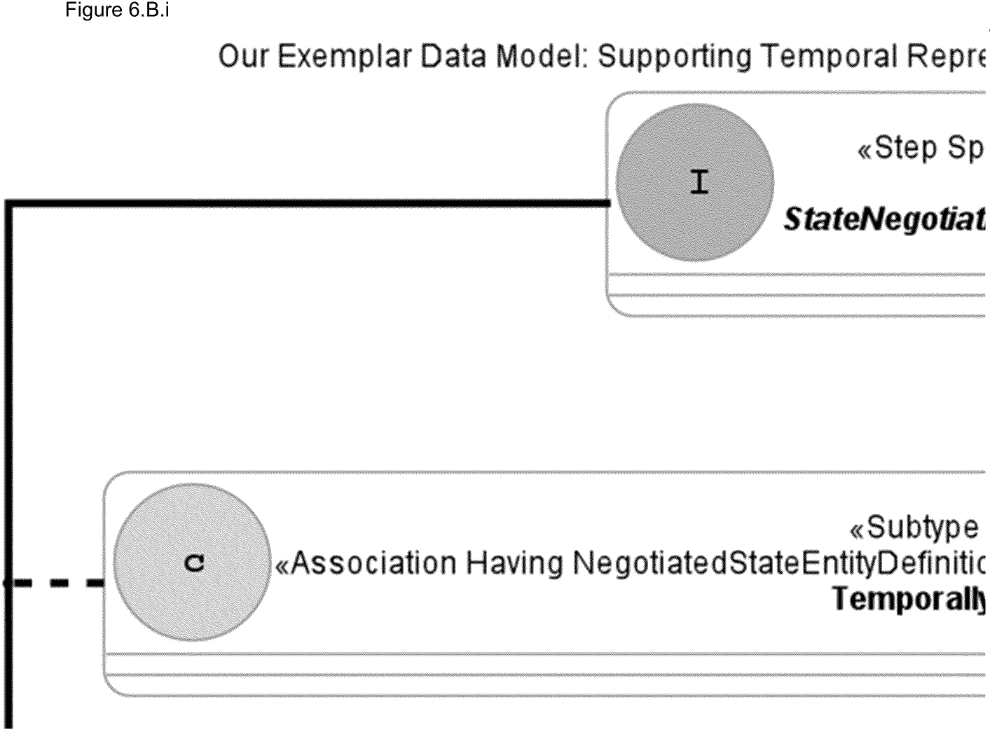

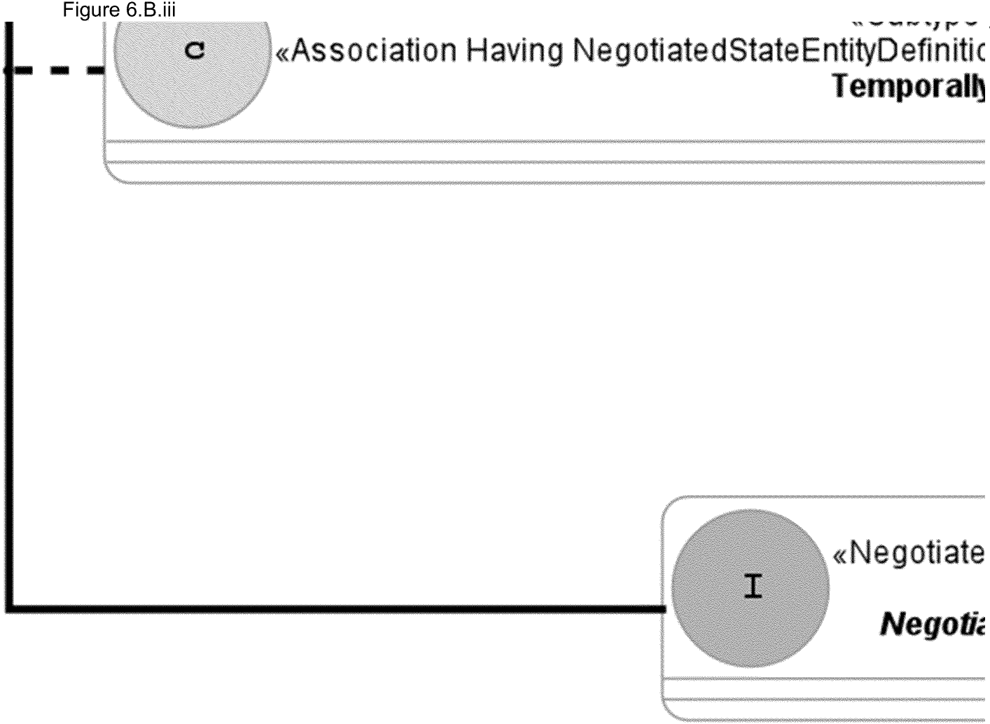

FIG. 6A shows a non-limiting, exemplary data schema in support of temporal state negotiation. As previously stated, the data model needs to be unambiguous in its definition when generating applications in an automated fashion. If the data model has different input requirements at different points in time, and those distinct representations are not clearly described in the data model as well as when they are appropriate, then custom code needs to be written by some entity capable of inferring such steps, such as a human engineer. In order to remove a human engineer from the process of service generation, the data model should be unambiguously defined. Such a definition preferably includes clear descriptions of data that can take on different forms over time. Examples of such data include exclusive rights ownership associations. Home ownership for example may require multiple data points to establish the contract that binds an owner to the owned asset. However, such data points may not all be applicable at a given point in time. It may be that submissions to this contract are required from multiple parties at multiple disparate points in time. If the obligations of each party, as well as the sequence in which they are to be submitted, is clearly defined in the data model, then a data management software application to manage these exclusive ownership transfers involving multiple party submissions, can still be auto generated using generic templates. Therefore, the exemplary data schema declares an abstraction or type union for both Primary Entities and Association Entities that is to be considered temporally. That is, rather than the type union being composed of multiple distinct conceptual data entities that can fulfill a given common obligation, the type union is composed of a singular conceptual entity but at different points in time.

These discrete intervals in time and their corresponding representations are labeled “StateNegotiationStepSpecificRepresentation” in the exemplary data model. Each representation is a subtype of this abstract concept of being a distinct temporal representation, rather than a distinct conceptual representation. The discrete concrete temporal representations can then be associated to one another much the same as distinct conceptual representations can be to compose a tree or graph of possible pathways the data’s form can take through time as negotiation of some future state is taking place. Both Primary Entity Definitions and Association Entity Definitions can have these temporal forms. They declare support for these temporal forms by indicating they are a subtype or more concrete form of what is labeled a NegotiatedStateEntityDefinition within the conceptual data model. As concrete forms of this NegotiatedStateEntityDefinition abstraction both declare support for association to a set of temporal representations. Note that support for describing the state of data through time is not necessary for generating an application but if the data can take on multiple forms over time and these forms are not described, then human or other generalizing intelligence based inference may be needed to implement code that constraints the state, at a given point in time, to the form appropriate at that time. The exemplary data model therefore includes support for clearly describing when and how such temporal representations are supported.

An Authority, which is a Polymorphic Primary Entity Type Union, determines which parts of the data specification may control other parts, for example with regard to reading or writing data, updating data and so forth. The exemplary data model as shown features a State Negotiation (4), which is provided as a series of steps, each of which features a Step Specific Representation (5). State Negotiation (4) Steps with Step Specific Representations (5) may be considered as a temporal Polymorphic Type Union, in which the different steps are performed over time. These representations correspond to the same conceptual data entity instance, but at different points in time. These discrete step specific representations can refer to one another to establish a flow and so the collection of these representations is a self-referential collection. Steps refer to other steps as possible subsequent steps a configuration data manager or approver can submit from a given base state.

As shown, a Field Definition (3) is a Temporal Polymorphic Type Union. The actual Field Definition Main provides the necessary definition of fields and the data contained therein, with regard to a single temporal instance of the Bounded Context abstraction (17). A set of fields is preferably used to generate the necessary relational database column definitions and user interface controls. Optionally additional field definition attributes could be supplied to support generation of user interface controls and database constraints for a given field. Alternatively, not all attributes shown in FIG. 2B for field definition are strictly necessary to generate a data management application, but the listed attributes are preferred for generating an application with a robust user experience.

The main field definition is preferably associated with a type union, allowing indirect association to either a Primary Entity (1) or an Association Entity (2). This provides another example of a polymorphic type union, where many forms of conceptual data can be associated to the same conceptual data entity for the same purpose.

Optionally the association is indirect. There is an intermediary conceptual data entity termed a “Step Specific Representation (5)” and this allows Field Definitions to be assigned to specific temporally variable representations of a given Primary Entity (1) or Association Entity (2). It is this explicitly described temporal variance in form that allows for the data model definition, when read and interpreted, to adequately describe to the automated application generation system, how to store, transfer, validate, authorize and present the data, at a given point in time, allowing for automated generation of not just relational data management applications, but also guided workflows for negotiating the state of data through time.

The main field definition may also be a Primary Entity, as the data model of the present invention may operate in a self-defined manner. Such a definition may include fields as distinct, required, generated and immutable Booleans; the value of pi; a string name and a string type. The main field definition then points to, or is associated with, a multi-step state negotiation, preferably with the valid next steps specified.

The Field Definition and the Authority are both associated with a particular State Negotiation (4). Each State Negotiation (4) is in turn associated with an Association Entity (2) State Negotiation Step Specific Schema and a definition of the Authorities Qualified to submit this step. Association Entity (2) also features a state negotiation flow definition, which as shown supports steps defining the flow for subsequent state negotiations. The support of the Relational Data Form for declaring and associating with such Polymorphic Type Unions increases the flexibility of the data form.

FIG. 6B shows how, within the exemplary data schema, the Primary Entity (1) and Association Entity (2) data types, which inherit from the exemplary “NegotiatedStateEntityDefinition” abstract concept, may be associated to multiple forms, that are distinct in terms of when a given form is relevant, rather than being distinct in terms of the conceptual role for the form. Note that the specific concept of a “State Negotiation Step Specific Representation (4)” or “Negotiated State Entity Definition” may be generalized, rather than being specifically defined. Preferably, the data and template designers agree in advance on a finite set of classifications for the types of data the application is to support, and that the data be defined consistently and unambiguously in terms of these agreed upon classifications, so that the templates can be authored against these concepts one time for any and all, present or future defined business domain specific data models. Ideally though, such agreed upon classifications should include classifications such as for data that defines a relationship, data that can take on many disparate conceptual forms or is polymorphic conceptually, and data that can hold different forms over time or is polymorphic temporally.

FIG. 7 shows a non-limiting, exemplary data schema with the definition of a Primary Entity (1). Within the exemplary data schema, a primary entity is considered to be any single, independently conceivable concept, modeled as a conceptual data entity. For example if a business domain included the commonly known concept of a “car” as something that needed to be configured for purchase, a car would be one such primary entity. Another concept that the example business may need to model to facilitate digital or virtualized interactions with their business, could be a person as a potential owner of a car. Contrast this with an Association Entity as is defined in FIG. 4, which cannot exist or be conceived of independently, such as the concept of a car ownership. It’s possible that there may be datapoints specific to the concept and occurrence of ownership and so there is a need to define these associative data entities. However, as this example of “car ownership” illustrates, there are two components to this example association data entity. The concept in this example requires both the definition of car and the definition of person as a potential owner, already existing. Ownership then could not be modeled in this exemplary data schema, with primary entities. An association entity would need to be defined to express and support the entering or sourcing of data that is specific to an occurrence of car ownership.

As mentioned previously, primary entities in the exemplary data model support multiple forms or may forms or “polymorphic” representations where different sets of data can be collected, pertaining to the entity, at different points in time. This figure expresses this capacity by defining an inheritance type relationship between a primary entity definition and a negotiated state entity definition. Indicating that primary entities can be defined with support for multiple temporal representations. The primary entity definition in the exemplary data model also illustrates this temporal nature as the definition itself is also a temporally enabled primary entity with one temporal state named “Main”. Currently, as depicted, there is one set of fields that can be configured to define a primary entity and so only the “main” representation exists. If multiple primary entities were to be configured over time, with multiple submissions, then multiple such representations are preferably defined, each with associations to a distinct set of field definitions. The last component depicted in this exemplary diagram is the definition of a polymorphic type union.

Primary entities in the exemplary data model can be defined with declarations for membership within a polymorphic type union. The primary entity defined is then considered to be one form, of the many forms, supported by this type union. Unlike the temporal representations supported by all subtypes of NegotiatedStateEntityDefinition, these distinct representations or forms within this polymorphic type union are entirely distinct concepts, but with some common obligation or capacity. For example a business domain may decide to model both the commonly known concept of a car and the concept of a truck as distinct primary entity definitions as they have distinct sets of configurable data points, but then incorporate both of these distinct concepts into a “motorized vehicle” abstraction or type union which may share some common obligation, associations or value.

Note that it is not required to define the specific concept of a “Primary Entity (1)”. All that is required is that the data and template designers agree in advance on a finite set of classifications for the types of data the application is to support, and that the data be defined consistently and unambiguously in terms of these agreed upon classifications, so that the templates can be authored against these concepts one time for any and all, present or future defined business domain specific data models. Ideally though, such agreed upon classifications should include classifications such as for data that defines a relationship, data that can take on many disparate conceptual forms or is polymorphic conceptually, and data that can hold different forms over time or is polymorphic temporally.

A single Primary Entity (1) is shown, again with a single temporal representation (17) as a subtype of the Primary Entity. The Primary Entity (1) has representations and definitions, which include the Primary Entity Definition and a detailed Main Definition. A subtype of an Association Entity (2) is also provided, defining the Type Union Membership. The Negotiated State Entity Definition (26) is in turn determined according to the representations and definitions, including the abstraction of the temporal polymorphic type union (17).

FIG. 8 shows a non-limiting, exemplary data schema with the definition of an Association Entity. As noted previously when detailing the contrast between Association Entities and Primary Entities, in the exemplary data schema, association entities are concepts that incorporate two or more disparate concepts and join them together, generally allowing for some additional data specific to the joining of the two disparate concepts to be defined and live and exist only while the association exists. The previously described example of “car ownership” is one such relational concept. Other examples may include associative concepts such as a “team membership”, which joins the disparate primary entity conceptual data concept of person to that of a team. In both of these examples, the data entity on either end of the association can exist without the entity on the other end. Therefore the exemplary data schema does not require the data specific to the concept of a person to be embedded within that of a team, or vice versa. Each is allowed to be defined and managed independent of the other, and the association is defined as a connecting component between them that is additive, allowing each distinct primary entity to continue to exist without any direct coupling point to the entity on the other end of the association. Note that while the exemplary data schema defines all associations in this way, it is not necessary for associations to be defined in this specific way, to support application generation. All that is required is that associations be unambiguously and consistently defined, so that they can be discovered and interpreted in an automated fashion without generalizing inference such as from a human engineer or other generalizing system. As with the primary entity definition, the association entity definition in the exemplary data model also allows for association to both an abstraction oriented polymorphic type union and a temporally oriented polymorphic type union via relationships with the PolymorphicAssociationEntitiesTypeUnionDefinition and the NegotiatedStateEntityDefinition respectively.

As shown, the NegotiatedStateEntityDefinition is associated with representations and associations of the Association Entity (2), and specifically with the association entity definition. This definition in turn is a generalization, which may be specified according to the main association entity definition as shown, which is a subtype of the Primary Entity (1). The Association Entity (2) itself has at least two subtypes, shown as the association entity observer and the observed constraint definitions, which determine the context and requirements for the specific instance of the Association Entity (2); and the association type union membership. The latter in turn determines the representations and associations of the polymorphic type union membership, which in turn is specified according to a subtype of the Primary Entity (1), with regard to the main definition of the polymorphic type union membership.

FIGS. 9 and 10 show exemplary instruction and data flows. As shown in FIG. 9, the data designer sends a request for the configuration information from the user agent, which is then passed to the data designer management service. This service passes the information back to the user agent, which uses this information to render the single page app (7) as previously described. The app (7) in this case helps the data designer to name and define the Primary Entity (1), and then to save it. This information is then passed to the data designer management service. The process is then preferably repeated until the data template has been fully defined.

In FIG. 10, as shown service access is authorized and a load balancer may be employed to spread the data service management load. Payload access is authorized. The input is checked against constraints. At the end of the process, if successful, the data designer’s input is stored as a bounded context and definition, and then published as the data template.

Some non-limiting examples of cloud based applications and the associated configuration data are described below.

### Configuration Data Example A

A user of a social networking application may configure which of other users should be in a “friend” list. The social networking application user interface rendering process is then altered by this configuration to render just those configured users in an area for friends. This is also an example of managing “single owner” configuration data. The user managing the friend list is the sole and exclusive owner of the configuration they are managing. There is no need to address concerns such as sharing rights to the configuration. There is also no need to address another common configuration data concern which is transfer of ownership of the configuration data.

### Configuration Data Example B

A manager of a video game’s rule set may configure the rules surrounding those actions that a player can take at a given point in the game session lifecycle. The manager may alter things like the magnitude of impact a player’s action may have on the game state or on other players. In this scenario, the configuration data being managed would generally be considered “shared ownership”. This data may be managed by a team of product managers or developers whose job is to balance out the game’s rule set. With this type of configuration data there are some additional concerns to address, such as for example, the definition of the entity that actually owns the data when it is created. If the owner is a team or group, then other concerns occur when managing the configuration state, such as how to associate created data with a specific team. Other concerns to address in this scenario include access rights and sharing, such as for example the determination of which users can see or manage the data.

### Configuration Data Example C

An organization manager may want to configure the hierarchy of the organization. In this example, the manager may wish to configure which members of an organization belong within a given team. This team membership may for example impact how an authorization component processes access requests for a given user of the organization software systems.

### Configuration Data Example D

A network administrator may wish to configure which domain names resolve to network IP addresses on which they host their software services. This case brings up the concern of exclusive ownership rights and negotiation over the state of configuration data. In this case, the system admin may be required to negotiate with some separate authority over the rights to a domain name, which is an exclusive property. For scenarios such as this, the network administrator is presumed to be unable to simply submit the desired configuration state to persist and finalize it. Instead, the administrator would be expected to submit only a request for the desired state. This requested state may then need to work through a negotiation process or flow, possibly undergoing modification and/or resubmission until all governing entities or authorities have approved the requested state. This approval may also be tied to or gated by some additional sub process such as the attachment or association to a purchase or other exchange. As a result, the submitted configuration data may be considered final and valid only when the entire negotiation is complete.

The process of negotiation that a state may undergo to reach a present or current state may be opaque to all referrers to this negotiated state. This is another benefit of supporting associations to data abstractions or polymorphic type unions. Augmenting a conceptual data entity with a state negotiation flow, need not break any existing references to that conceptual data entity. At this point, once final, the configuration data can be linked to other configuration data and used just as if it had been submitted and finalized in a single step. In its “referenced” or “read-only” form, the negotiated configuration data behaves just like any other configuration data.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for automatically generating a deployment of an application in a computer system, comprising receiving, by an application data processor, a relational data form, defining data according to a unambiguous relational data form with any abstractions explicitly and consistently defined, and a set of templates for resources to be produced, wherein said templates are defined in any order with respect to the data definition; providing said relational data form to said templates as inputs to said application data processor; creating a data infrastructure for deployment by said application generation processor; and creating user interface instructions by said application generation processor.

2. The method of claim 1, wherein said relational data form describes the configuration data to be hosted relationally, in a schema or format which then supports the subsequent steps of the method.

3. The method of claim 2, further comprising generating said relational data form according to a set of fields by a computational device in the computer system to generate the necessary relational database column definitions and user interface controls.

4. The method of claim 3, further comprising generating said data definition according to structural constraints and data definition obligations of said relational form by said computational device; wherein said data definition comprises a set of temporally specific fields, defined according to said relational form; wherein said data definition is processed for automated generation of requisite data related resources.

5. The method of claim 4, further comprising selecting said set of templates according to components in the deployment that are being generated.

6. The method of claim 5, further comprising defining Infrastructure as code (IaC) templates by said computational device for provisioning virtualized compute, storage and volatile memory resources needed to host the data access service components and data access storage.

7. The method of claim 6, wherein said relational data form defines a plurality of data elements that resolve concrete values for various configurable regions within said templates.

8. The method of claim 7, wherein said data elements comprise a plurality of entities, including at least one Primary Entity and at least one Association Entity, wherein each Association Entity belongs to one Primary Entity.

9. The method of claim 8, wherein each Primary Entity belonging to a particular type union is capable of interactions as defined with regard to that type union.

10. The method of claim 9, wherein each Association Entity inherits from said Primary Entity type union.

11. The method of claim 10, wherein each Association Entity is defined, according to said Association Entity Definition, as supporting in assignment to any end of the association, an instance of any Primary Entity; wherein said Primary Entity, defined explicitly, is declared as a member of Polymorphic Type Union; wherein said Polymorphic Type Union is defined as supported by the Association Entity Definition as compatible with said association end.

12. The method of claim 11, wherein said Polymorphic Type Union comprises a plurality of distinctly defined types of Primary Entity.

13. The method of claim 1, wherein said relational data form supports explicit definition of data model associations in a consistent manner.

14. The method of claim 1, further comprising defining a data flow as a state negotiation for a plurality of states according to said relational data form and said set of templates.

15. The method of claim 14, wherein said plurality of states comprise temporally distinct representations of said states.

16. The method of claim 1, wherein said deployment comprises a cloud deployment; the method further comprising provisioning a cloud based machine by a virtualization platform, operated according to a computational device in the computer system, according to said data infrastructure.

17. The method of claim 16, wherein said provisioning said cloud based machine comprises provisioning through said virtualization platform selected from the group consisting of KVM, VMware Workstation, VMware Fusion, Hyper-V, Windows Virtual PC, Xen, Parallels Desktop for Mac, Oracle VM Server for SPARC, VirtualBox, and Parallels Workstation.

18. The method of claim 17, wherein said computer system further comprises a user agent accessible to a user, the method further comprising creating a user interface according to said user interface instructions.

19. The method of claim 18, wherein said user agent comprises a web browser.
